(19) United States
(12) Patent Application Publication
(10) Pub. No.: US 2004/0171718 A1
(43) Pub. Date: Sep. 2, 2004

(54) Water-based cyan ink for ink-jet printing, color ink set containing the same and image forming method using the ink set

(76) Inventors: Masaki Nakamura, Tokyo (JP); Atsushi Tomotake, Tokyo (JP); Hirotaka Iijima, Tokyo (JP)

Correspondence Address: Squire, Sanders & Dempsey L.L.P., One Maritime Plaza, Suite 300, San Francisco, CA, 94111, US

(21) Appl. No.: 10/781,280

(22) Filed: Feb. 17, 2004

(30) Foreign Application Priority Data
Feb. 27, 2003 (JP) JP2003-050824

(51) Int. Cl. C09D 11/02; C03C 17/00

(52) U.S. Cl. 523/160; 106/31.6; 523/161

(57) ABSTRACT

A water-based cyan ink for ink-jet printing, comprising pigment particles or water insoluble colored polymer particles, wherein an ink-jet image is formed by jetting the water-based cyan ink on a porous ink-jet recording sheet with an ink-jet printer without being subjected to an post-treatment, and the ink-jet image has the following set of color coordinate values in a L*a*b* color space when L* is in a range of 65<L*<75:

(i) −20<a*<20; and

(ii) −20<b*<20.

### TECHNICAL FIELD

The present-invention relates to a novel ink-jet water-based cyan ink, an ink-jet color ink set using the same and an image forming method, and in more detail to a water-based cyan ink-jet ink which exhibits improved ink dispersion stability, and ejection stability, as well as excellent appearance of gloss (bronzing resistance) and lightfastness of formed images, as well as an ink-jet color ink set and an image forming method using the same.

### BACKGROUND

Ink-jet recording is carried out in such a manner that images and text are recorded by ejecting and depositing minute ink droplets onto recording media utilizing various working principles, and exhibits advantages such as relatively high speed, low noise and the ease of multicolor formation.

Further, ink-jet prints employing dye inks have increasingly been employed due to the high image quality approaching conventional silver salt photography as well as a decrease in price of apparatuses brought about by recent technical progress.

Dyes are soluble in solvents and dye molecules are subjected to dying in a molecular or cluster state. Since the environment of each molecule is similar, its absorption spectrum is sharp and results in clear coloring of high purity. In addition, there occur no granular patterns due to particles. Further, when images are formed on a glossy paper while targeting conventional photographic quality, dyes penetrate from the paper surface to the interior, whereby the images are formed. As a result, neither scattered light nor reflection light occurs, whereby it is possible to obtain clear ink-jet images with bright hues.

On the other hand, however, when dye molecules are decomposed through photochemical reactions, a decrease in the number of dye molecules directly affects coloring density. As a result, a problem occurs in which lightfastness is degraded. Ink-jet recording images comprised of dye inks result in high quality, but result in marked degradation of image quality during storage. In view of the image stability during storage, at present, no techniques are available which allow to exceed the image stability of conventional silver salt photography.

Consequently, by using dyes which result in high quality images approaching conventional photographic quality, attempts have been made to produce ink-jet images with high fastness. One of the methods proposed is one in which dyes are covered by polymers and protected. Further, a method is known in which water-insoluble transparent particles, so-called latexes, are added to water-soluble dyes. These methods result in assured effects to minimize bleeding resistance as well as abrasion resistance, but lightfastness and fade resistance have not reached the desired quality.

On the other hand, proposed is a method in which water dispersible resins are colored by oil-soluble dyes and hydrophobic dyes. For example, Japanese Patent Publication Open to Public Inspection (hereinafter referred to as JP-A) Nos. 55-139471, 58-45272, 3-250069, 8-253720, 8-92513, 8-183920, and 2001-11347 propose inks which employ emulsion polymerization particles or dispersed polymerization particles dyed with oil-soluble dyes.

Further, JP-A No. 2001-19880 proposes minute colored particles impregnated with chelate dyes and discloses the fact that the resulting print density, lightfastness, and hues are improved. However, the aforesaid method results in problems in which when compared to conventional photographic images as a target, image bleeding resistance as well as lightfastness is insufficient, and further, the stability of the resulting minute colored particle dispersion is degraded. On the other hand, JP-A No. 2001-139607 proposes a method to minimize clogging of ink heads and to enhance contact adhesion properties by employing core/shell type double-structured minute colored particles impregnated with chelate dyes. Still further, JP-A No. 2001-329199 proposes a method, in which polymer particles, prepared employing only hydrophobic monomers of resins which contain colorants, are incorporated. However, in the aforesaid methods, when images are formed on glossy paper, problems similar to those of pigments described below occur due to residual minute colored particles on the glossy paper surface.

Contrary to the aforesaid dye inks, employed as inks for the use which necessitates images of high antifading properties to light are pigments inks in which pigments with desired lightfastness are employed as a colorant. However, pigments are present in the form of pigment particles, being different from dyes, and tend to scatter light. Specifically, when images are formed employing glossy paper in order to achieve conventional photographic quality, the image surface results in glare with metallic gloss and different hue, the so-called bronzing phenomena, when the image surface is viewed obliquely, since images are formed on the surface of the glossy paper. These have become undesirable factors which result in quality different from conventional photographic quality. Further, since pigment images are formed on the surface of the glossy paper, at present, problems occur in which when the image surface is rubbed, the image is removed, abrasion resistance is degraded, dispersion stability in the ink is degraded, and clogging occurs during ejection of the ink from the head. Various improvements for pigment inks have been made to overcome the aforesaid problems, while maintaining high durability of the resulting images.

For example, in JP-A Nos. 10-287837, 11-49995, 2000-169769, and 2000-351931, trials are proposed in which improvements in abrasion resistance and enhancement of image quality are simultaneously achieved by using combinations of pigment particles and latex particles. Improvements in abrasion resistance of images obtained by these embodiments were significant but glare and bronzing of images printed on glossy paper were not sufficiently minimized. Further, it is extremely difficult to simultaneously assure the dispersion stability of pigment particles in the ink and the dispersion stability of latex particles. Regarding inks which are comprised of only pigment particles, improvement is barely noticed for problems of the storage stability and ejection stability of the ink.

On the other hand, proposed as one of the embodiments, in which advantages obtained by employing pigment particles and latex particles are further developed, are polymer-coated pigments which are prepared by covering the surface of pigment particles with polymers. For example, described in JP-A No. 8-71405 is a method in which pigment particles are dispersed employing polymer compounds, and after dissolving the polymer compounds in organic solvents, phase inversion emulsification is carried out in water; described in Shikizai Kyoukaishi (Journal of the Japan Society of Color Material), 70, 503 (1997), is a polymerization method after allowing monomers to adsorb on the surface of pigment particles; and described in Shikizai Kyoukaishi (Journal of the Japan Society of Color Material), 69, 743 (1996) and 72, 748 (1999) is a method in which after introducing polymerization initiators to the surface of pigment particles, polymerization is carried out in the presence of monomers. Since in these methods, strong polymer layers are formed on the surface of pigment particles, and free polymer compounds are not present in the pigment ink, it is possible to prepare a pigment ink of high dispersion stability. However, even though such polymer-coated pigments are employed, the feeling of glare and bronzing of the images formed on the glossy paper have not sufficiently been minimized.

Further, other methods are proposed in which the feeling of glare as well as bronzing is minimized even though glossy paper is employed. For example, an ink-jet recording ink composition is proposed in which bleeding resistance, dispersion stability, and ejection stability are improved in such a manner that pigments, resinous dispersing agents, thermoplastic resinous emulsion, and water are incorporated and the composition ratio of the pigments to the resinous dispersing agents is specified in specific ranges (refer, for example, to Patent Document 1). Further, an ink-jet ink which exhibits improved glossiness and abrasion resistance is proposed, which comprises a carrier medium, colorants, and thermoplastic polymer particles, and in which said polymer particles have the specified glass transition temperature as well as the specified average diameter. Further, proposed is an image forming method which enables improvement of glossiness, abrasion resistance, and releasing properties in such a manner that after allowing a pigment ink comprising dispersing agents to adhere to an ink-jet recording medium which comprises a support having, as an uppermost layer, an ink receptive layer comprising thermoplastic resinous particles and a pigment ink solvent absorptive layer adjacent to said ink receptive lawyer, employing an ink-jet method, the thermoplastic minute particle ink receptive layer as the uppermost layer is transparentized by simultaneously applying heat and pressure (refer, for example, to Patent Documents 2 and 3). However, in all the methods described above, after forming images, a heating process, a pressure applying process or a heating and pressure applying process is required to melt the thermoplastic resins or to modify them to a layer. As a result, the image forming process becomes complicated or requires additional facilities, whereby cost increases.

On the other hand, proposed is a water-based ink-jet ink comprising a pigment ink and water-soluble polymers such as shellac resins at a specific ratio to minimize capping phenomena and exhibit excellent water resistance (refer, for example, to Patent Document 4). By employing shellac resins at the specific ratio, glossiness is assuredly improved to some extent. However, the feeling of glare and bronzing, which are the problems of the present invention are not sufficiently minimized. In addition, problems still remain in which due to the presence of pigments together with resins, the dispersion stability and ejection stability of the ink are insufficient.

(Patent Document 1)

JP-A No. 9-176533 (claims)

(Patent Document 2)

JP-A No. 2000-80316 (claims)

(Patent Document 3)

JP-A No. 2001-341407 (claims)

(Patent Document 4)

JP-A No. 2000-273375 (claims)

### SUMMARY

In view of the aforesaid problems, the present invention was achieved. An objective of the present invention is to provide a water-based cyan ink-jet ink which exhibits improved dispersion stability and ejection stability of the ink and still results in excellent feeling of gloss (bronzing resistance) and excellent lightfastness of the formed image, as well as an ink-jet color ink set and an image forming method using the same.

The aforesaid objective of the present invention is achieved employing each of the embodiments described below.

(1) A water-based cyan ink for ink-jet printing, comprising pigment particles or water insoluble colored polymer particles,

wherein an ink-jet image is formed by jetting the water-based cyan ink on a porous ink-jet recording sheet with an ink-jet printer without being subjected to an post-treatment, and the ink-jet image has the following set of color coordinate values in a L*a*b* color space when L* is in a range of 65<L*<75:

(i) −20<a*<20; and

(ii) −20<b*<20.

(2) The water-based cyan ink of Item 1, wherein the pigment particles or the water insoluble colored polymer particles has a volume average particle diameter of 10 to 200 nm.

(3) The water-based cyan ink of Items 1 or 2 further comprises a water-soluble polymer and secondary particles of the pigment particles or the water insoluble colored polymer particles satisfy Formula (1):

10X^{-0.7}<Y<40X^{-0.7} Formula (1)

wherein X is a volume average particle diameter; and

Y is a polydispersity index which is defined by the following formula:

Y=(D₉₀-D₁₀)/D₅₀,

wherein D₉₀, D₅₀, and D₁₀ are respectively particle diameters at which an integral of a distribution function dG (dG=F(D)×dD) is equal to 0.9 (90 volume %), 0.5 (50 volume %) and 0.1 (10 volume %) of the total volume of the secondary particles or the water insoluble colored polymer particles, wherein G is a volume of the particle, D is a diameter of the secondary particle and F(D) is a volume frequency function.

(4) The water-based cyan ink of any one of Items 1 to 3 further comprises a water-soluble polymer in an amount of not less than 2 times of weight of the pigment particles or the water insoluble colored polymer particles.

(5) The water-based cyan ink of any one of Items 1 to 3, wherein the water insoluble colored polymer particles are covered with a pigment or a dye on a surface of the particles.

(6) The water-based cyan ink of Item 5, wherein a weight ratio of the polymer to the pigment is 0.6:1 to 10:1.

(7) The water-based cyan ink of Item 5, wherein a weight ratio of the polymer to the dye is 0.4:1 to 10:1.

(8) An ink set for ink-jet printing containing a water-based cyan ink which comprises pigment particles or water insoluble colored polymer particles,

wherein an ink-jet image is formed by jetting the ink set on a porous ink-jet recording sheet with an ink-jet printer without being subjected to an post-treatment, and the ink-jet image has the following set of color coordinate values in a L*a*b* color space when L* is in a range of 50<L*<90:

(i) −20<a*<20; and

(ii) −20<b*<20.

(9) An ink set of Item 8 containing the water-based cyan ink of any one of Items 1 to 7.

(10) A method for producing an ink-jet image using the water-based cyan ink of any one of Items 1 to 7.

(11) A method for producing an ink-jet image using the ink set of Items 8 or 9.

In view of the aforesaid problems, the inventors of the present invention conducted diligent investigations. As a result, the following were discovered. In a water-based cyan ink-jet ink comprising at least pigment particles or water-insoluble colored particles, or an ink-jet color ink set comprising a water-based cyan ink-jet ink comprising at least pigment particles or water-insoluble colored particles in which a specific value the L*a*b* chromaticity diagram (or called as L*a*b* color space, each L*, a*, and b* being a coordinate of the color space) of the ink-jet recording image which is formed, without a post-treatment, by ejecting said cyan ink onto a porous ink-jet recording sheet, employing an ink-jet recording system, as hue viewed employing the normal reflection light of 45-degree variable angle reflection is within the range of −20<a*<20 and −20<b*<20, when 65<L*<75 is specified, by employing an ink-jet color ink set in which a specific value the L*a*b* chromaticity diagram of the ink-jet recording image including the cyan image which is formed, without a post-treatment, by ejecting said ink-jet colored ink onto a porous ink-jet recording sheet, employing an ink-jet recording system, is within the range of −20<a*<20 and −20<b*<20, when 50<L*<90 is specified, it was discovered that formed images exhibited excellent glossiness and feeling of transparency, as well as resulted in excellent bronzing resistance. Surprisingly, it was also discovered that the dispersion stability and ejection stability of the aforesaid ink were greatly enhanced. Thus the present invention was achieved.

In addition to the aforesaid embodiments, it was also discovered that the aforesaid effects were further pronounced employing the water-based cyan ink-jet ink in which the volume average diameter of the employed pigment particles or water-insoluble colored particles was 10-200 nm; water-insoluble transparent particles or water-soluble polymers were incorporated and the secondary particle diameter distribution values were within the range of specified values; pigment particles as well as water-insoluble transparent particles or water-soluble polymers were incorporated and the content amount of the total polymer components in the ink was at least twice the colorant amount; the water-insoluble colored particles were comprised of polymer-coated pigments or polymer-coated dyes; in the polymer-coated pigments, the amount of polymer components was 0.6-10 times the colorants and in the polymer-coated dye, the amount of polymer components was 0.4-10 times the amount of the colorants.

Generation mechanism of the effects under conditions specified by the present invention is not yet clearly understood. However, it is assumed to be as follows. The ink in which the hue under normally reflected light of a 45-degree variable angle reflection is within the specified range on L*a*b*, is comprised of polymer resin-coated colorant particles or transparent resinous particles (latex particles) having a nearly similar surface polarity as well as colored particles. As a result, aggregation due to the difference in surface polarity decreases to reduce the interaction among particles, whereby the dispersion stability of the ink as well as the ejection stability at heads is enhanced.

### BRIEF DESCRIPTION OF THE DRAWINGS

FIG. 1 shows a distribution function curve of a volume diameter represented by D₁₀, D₅₀, and D₉₀ according to the present invention.

### DESCRIPTION OF THE PREFERRED EMBODIMENTS

The present invention will now be detailed.

The water-based cyan ink-jet ink (hereinafter also referred simply to as cyan ink) of the present invention, comprising at least pigment particles or water-insoluble colored particles, is characterized in that a value on the L*a*b* chromaticity diagram of the ink-jet recording image which is formed, without a post-treatment, by ejecting said cyan ink onto a porous ink-jet recording sheet, employing an ink-jet recording system, is within the range of −20<a*<20 and −20<b*<20, when 65<L*<75 is specified. Further, the ink-jet color ink set (hereinafter also referred simply to as the ink set) of the present invention, comprising a water-based cyan ink-jet ink comprising at least pigment particles or water-insoluble colored particles is characterized in that a value on the L*a*b* chromaticity diagram of the ink-jet recording image including the cyan image which is formed, without a post-treatment, by ejecting said colored inks onto a porous ink-jet recording sheet, employing an ink-jet recording system, is within the range of −20<a*<20 and −20<b*<20, when 50<L*<90 is specified.

A set of L*a*b* values(CIE 1976) which represents a chromaticity point specified in the present invention is determined based on JIS Z 8722 and 8717 and is specified by Color Specification Method specified in JIS Z 8730. Value L* represents a lightness index, while value a*b* represents a perceived chromaticity index.

The cyan ink of the present invention is characterized in that a set of L*a*b* values of the cyan image on the chromaticity diagram is within the range of −20<a*<20 and −20<b*<20, when 50<L*<90 is specified, and is more preferably in the region of −10<a*<10 and −10<b*<10.

Further, the ink set of the present invention is characterized in that a set of L*a*b* values of the cyan image on the chromaticity diagram is within the range of −20<a*<20 and −20<b*<20, when 50<L*<90 is specified, and is preferably within the range of −15<a*<15 and −15<b*<15, and is more preferably within the range of −10<a*<10 and −10<b*<10.

It is possible to determine L*a*b* specified in the present invention employing, for example, GL2000, manufactured by Nippon Denshoku Industries Co., Ltd., an X-Rite Co. densitometer (X-Rite 938), Gretag SPM-1000 and colorimetry standard black backing, a calorimeter (CR-100, manufactured by Minolta Co., Ltd.), and a color analyzer (CMS-1200, manufactured by Murakami Color Research Laboratory).

In the present invention, used were values determined employing GL2000, manufactured by Nippon Denshoku Industries Co., Ltd under the conditions of a C light source of 2 degrees, a range of 3, an incident angle of −45 degrees, and a detection angle of 45 degrees.

Further, the ink-jet recording image formed without a post-treatment, as described in the present invention, means that an image formed on an ink-jet recording medium is not subjected to post-treatment processes such as a heating process, a pressuring process, a heating and pressuring process, or image smoothing carried out by a laminating treatment, or an image coating treatment carried put by spraying polymer components, such as latexes, onto images.

Means to achieve values on the L*a*b* chromaticity diagram are not particularly limited as long as the used ink comprises pigment particles or water-insoluble colored particles. In the present invention, the aforesaid values are achieved by selecting any of the cyan inks from those in which the volume average diameter of pigment particles or water-insoluble colored particles used in the cyan ink should 10-200 nm; water-insoluble transparent particles or water-soluble polymers should be incorporated and the secondary particle diameter distribution value should be within the specified range; pigment particles as well as water-insoluble transparent particles or water-insoluble polymers should be incorporated and the content of the amount to the total polymer components in the ink should be at least two times the amount of colorants; water-insoluble colored particles should be comprised of polymer-coated pigments or polymer-coated dyes; the amount of polymer-coated dyes should be 0.6-10 times the colorant amount; the amount of polymer-coated dyes should be 0.4-10 times the amount of colorants or in combinations thereof.

Further, in the present invention, it is preferable that pigment particles as well as water-insoluble transparent particles or water-soluble polymers are incorporated. If desired, water-insoluble transparent particles or water-soluble polymers may be employed together with polymer-coated pigments or polymer-coated dyes.

Pigment particles or water-insoluble colored particles (hereinafter also referred simply to as minute colored particles) according to the present invention will now be described.

It is possible to prepare the dispersion, according to the present invention, comprising the pigment particles employing prior art dispersion methods in which homogenizers such as a ball mill, a sand mill, an attritor, a roll mill, an agitator, a Henschel mixer, a colloid mill, an ultrasonic homogenizer, a pearl mill, a wet system jet mill, or a paint shaker are employed. Further, it is preferable that some of the coarse particles are removed employing a centrifuge or various filters. Still further, when pigments are dispersed, it is possible to add dispersing agents, whose types are not particularly limited. Examples include high fatty acid salts, alkyl sulfates, alkylester sulfates, alkyl sulfonates, sulfosuccinates, naphthalene sulfonates, alkyl phosphates, polyoxyalkylene alkyl ether phosphates, polyoxyalkylene alkyl phenyl ether, polyoxyethylene polyoxypropylene glycol, glycerin ester, sorbitan ester, polyoxyethylene fatty acid amide, surface active agents such as amine oxides, as well as block copolymers and random copolymers comprised of at least two compounds selected from styrene, a styrene derivative, a vinylnaphthalene derivative, acrylic acid, an acrylic acid derivative, maleic acid, a maleic acid derivative, itaconic acid, an itaconic acid derivative, fumaric acid, and a fumaric acid derivative, and salts thereof. Of these, polymer dispersing agents are preferably employed. Listed as polymer dispersing agents are, for example, the Solsperse Series, available from Avecia Co., and the Solsperse Series, available from Zeneca Co. In addition, as a dispersing aid, it is possible to use synergists corresponding to each of the various types of pigments. It is preferable that these dispersing agents as well as dispersing aids are added in an amount of 1-50 parts by weight with respect to 100 parts by weight of polymer-coated pigments or pigments.

Further, it is possible to prepare the minute colored particles according to the present invention by employing various methods. Listed as methods are, for example, a method in which oil-soluble colorants are dissolved in monomers, and the resulting mixture is emulsified in water followed by sealing the colorants in the polymer through polymerization; a method in which polymers and colorants are dissolved in organic solvents, and the resulting mixture is emulsified in water followed by removing the organic solvents; and a method in which minute porous polymer particles are added to polymers so that colorants are allowed to adhere to and impregnate with the minute particles. Further, it is possible to use a shell forming method in which these minute colored particles are covered by polymers.

Polymer shell providing methods include a method in which water-soluble polymer dispersing agents are added to a water-based core suspension to result in adsorption; a method in which monomers are gradually dripped to result in adsorption onto the core surface while simultaneously polymerized; and a method in which polymers dissolved in organic solvents are gradually dripped to result in adsorption onto the core surface while simultaneously being deposited. Further, a method is considered in which the core/shell is formed in a single step. Examples include a method in which polymers to result in cores and dyes, as well as polymers to result in shells, are heated and dissolved, and thereafter the resulting mixture is polymerized while suspended in water; and a method in which the aforesaid liquid composition is emulsion-polymerized while gradually dripped into water comprising surface active agent micelles.

The minute colored particles are not particularly limited, and may be in the form of a shell or not. In view of the effects of the invention, a core-shell structure is preferred in which the surface of resins in which minute colored particles comprise colorants is further covered by resins. In such a case, the amount of polymers used to form shells is preferably 5-95 percent by weight with respect to the amount of the total polymers. When the amount of polymers is at most 5 percent by weight, some portion of the core which contains colorants in a large amount tends to appear on the particle surface due to the insufficient thickness of the shell. On the other hand, when the amount of polymers is excessive, the protective function for colorants tends to be degraded due to the relative decrease in the amount of the core polymers. Consequently, the aforesaid amount is more preferably 10-90 percent by weight.

In the present invention, when minute colored particles are comprised of polymer-coated pigments, the amount of polymer components is preferably 0.6-10 times the amount of colorants. On the other hand, when minute colored particles are comprised of polymer-coated dyes, the amount of polymer components is 0.4-10 times the amount of colorants. When the amount of the colorants is excessively small with respect to the polymers, image density after ink ejection does not increase, while when the colorant ratio is high, the intended effects of the present invention are not achieved.

In the present invention, evaluation of how much the core-shell is actualized is important. In the present invention, each primary particle diameter is exceedingly small. As a result, in view of resolution, it is preferable that employed as analytical methods are a transmission type electron microscope (TEM) and a time of flight type secondary ion mass spectrometer (TOF-SIMS). When minute colored particles in the form of the core/shell are observed employing TEM, it is possible to carry out observation in such a manner that a dispersion is applied onto a carbon substrate and subsequently dried and then observed. Images observed by TEM are commonly monochromatic. Therefore, it is preferable that the polymers of either the core or the shell are dyed and then observed. In the case of TOF-SIMS, confirmation is carried out by detecting a decrease in the dye amount near the surface while providing a shell on the particle surface.

The volume average diameter of the pigment particles or the minute colored particles according to the present invention is preferably 10-200 nm, is more preferably 20-150 nm, and is most preferably 20-120 nm. By realizing the volume average particle diameter specified in the present invention, it is possible to preferably and completely exhibit the effects of the present invention.

It is possible to measure the average diameter of the pigment particles or the minute colored particles specified in the present invention as follows. An ink liquid which have been subjected to the desired operation is measured employing a light scattering particle diameter distribution measuring apparatus such as a Zeta Sizer 1000, manufactured by Malvern Co.

Further, in view of the coated layer strength after printing, its durability, and suspension forming properties, the number average molecular weight of polymers employed to prepare the minute colored particles is preferably 500-100,000, and is particularly preferably 1,000-30,000.

Still further, it is preferable that the cyan ink of the present invention comprises water-insoluble transparent particles or water-soluble polymers, described below, and further that the secondary particle diameter distribution value of the pigment particles or the minute colored particles satisfies the conditions of Formula (1) below.

10X^{-0.7}<Y<40X^{-0.7} Formula (1)

In Formula (1), X represents the diameter (in nm) of pigment particles or water-insoluble colored particles at D50, Y (polydispersity index) represents [(D₉₀-D₁₀)/D₅₀], and each of D₉₀, D₅₀, and D₁₀ represents a particle diameter in which the integral of each distribution function dG=F(D)×dD (wherein G is the number of water-insoluble colored particles and D is the particle diameter) equals to each of 0.9 (90 percent by volume), 0.5 (50 percept by volume), and 0.1 (10 percent by volume) of the total number of the water-insoluble particles. Incidentally, the volume average diameter of the pigment particles or the water-insoluble colored particles according to the preset invention is the same as D₅₀ defined herein.

Y (polydispersity index), as described in the present invention, is defined as follows.

The polydispersity index (PDI), as described in the present invention, refers to the index which defines particle diameter distribution of a dispersion and is defined as [(D₉₀-D₁₀)/D₅₀], as described above.

The aforesaid formula will now be described with reference to the drawing.

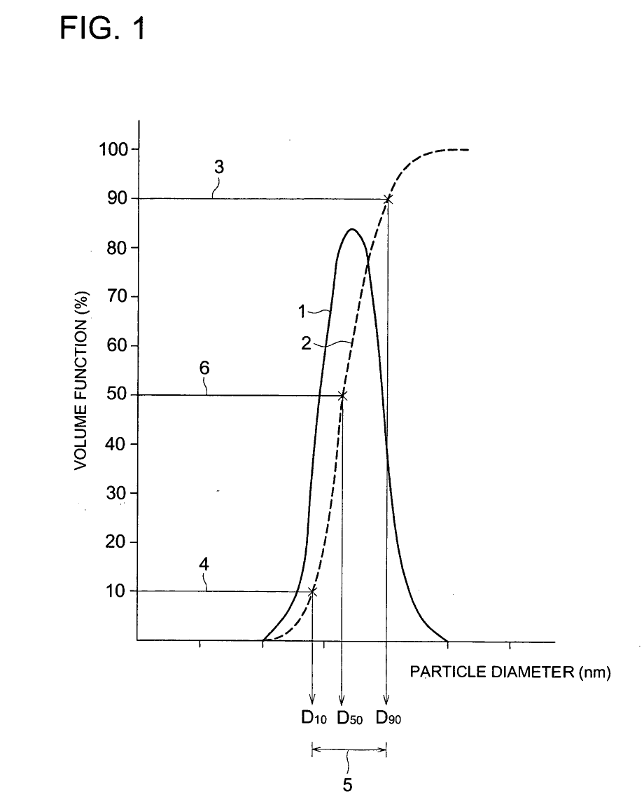

In FIG. 1, each number indicates the followings:

1: volume particle diameter distribution curve of the secondary particles of the pigment

2: integral curve of the volume particle diameter distribution function

3: line which corresponds to D₉₀

4: line which corresponds to D₁₀

5: value indicating (D₉₀-D₁₀)

6: line which corresponds to D₅₀

In FIG. 1, diameter (D) of pigment particles or minute colored particles is plotted on the abscissa, and volume particle function (G) of each of the pigment particles or the minute colored particles at each of the specified size is plotted on the ordinate. In such a coordinate system, the curve of the volume particle diameter distribution function of the pigment particles or the minute colored particles is shown as a solid line. Further, in the same coordinate system, the broken line curve shows the integral of the distribution function which is drawn by connecting each of the intersections which correspond to the points of 10, 50, and 90 percent of the volume particle function and the points of D10, D50, and D90 (being the volume average particle diameter) related to the volume particle diameter, respectively.

In the present invention, methods which allow the difference between D₉₀ and D₁₀ of pigment particles or minute colored particles to be placed in the range of specified Y are not particularly limited. However it is possible to prepare inks having the desired size distribution in such a manner that, for example, the type of cyan colorants, the type of polymers, the dispersing agents for pigment particles or minute colored particles, the dispersing means, the dispersing conditions, the type and added amount of surface active agents are suitably selected to be optimal, and the resulting dispersion of pigment particles or minute colored particles is subjected to centrifugal separation or filtration to remove excessively tiny particles as well as coarse particles.

In the present invention, it possible to use polymers having various Tg values. However, it is preferable that at least one of the employed polymers has a Tg of at least 10° C.

In the present invention, employed as polymers used for polymer-coated dyes may be all the polymers which are generally known. However, in view of dissolving and incorporating dyes, polymers for the core portion of the polymer-coated dyes are preferably those which exhibit high compatibility with dyes. Particularly preferred polymers include those having an acetal group, a carbonic acid ester group, a hydroxyl group or an ester group as a major functional group. The aforesaid polymers may have a substituent, which may have a straight chain, branched chain, or ring structure. Further, the various aforesaid polymers having a functional group are commercially available, but may be synthesized employing conventional methods. Still further, these copolymers are prepared in such a manner that for example, an epoxy group is previously introduced into one polymer molecule and subsequently undergoes condensation polymerization with other polymers, or light or radiation graft polymerization.

Preferably listed as polymers having an acetal group as a major functional group may be polyvinyl butyral resins, which include, for example, #2000-L, #3000-1, #3000-2, #3000-4, #3000-K, #4000-1, #4000-2, #5000-A, #6000-C, and #6000-EP, manufactured by Denki Kagaku Kogyo K. K.; and BL-1, BL-1H, BL-2, BL-2H, BL-5, BL-10, BL-S, BL-SH, BX-10, BX-L, BM-1, BN-2, BM-5, BM-S, BM-SH, BH-3, BH-6, BH-S, BX-1, BxX-3, BX-5, KS-10, KS-1, KS-3, and KS-5, manufactured by Sekisui Chemical Co., Ltd.

Polymers having an acetal group as a major functional group, as described herein, refer to those in which at least 30 mol percent oxygen atoms comprised in the polymers form an acetal group. Employed as other polymers having an acetal group as a major functional group may be the Upital Series, manufactured by Mitsubishi Engineering Plastics Co., Ltd.

Listed as polymers having a carbonic ester as a major functional group are polycarbonate resins. Examples include the Upiron Series and the Novalex Series, also manufactured by Mitsubishi Engineering Plastics Co., Ltd.

Polymers having a carbonic acid ester group as a major functional group, as described herein, refer to those in which at least 30 mol percent oxygen atoms comprised in the polymers form a carbonic acid ester group.

Employed as polymers used in the shell portion may be polymers having a hydrophobic portion as well as a hydrophilic portion. It is preferable to have monomers which are selected from hydrophobic monomers such as ethylene, propylene, butadiene, vinyl chloride, vinylidene chloride, vinyl acetate, styrene, (meth)acrylic acid alkyl ester, or (meth)acrylic acid allyl ester, with monomers selected from hydrophilic monomers such as monomers having a hydroxyl group such as hydroxyethyl (meth)acrylate, or (meth)acrylic acid polyethylene glycol monoester, monomers having a carboxylic acid such as (meth)acrylic acid, itaconic acid, or maleic acid, monomers having sulfonic acid such as styrene sulfonic acid, or sulfobutyl (meth)acrylate, or monomers having an amide group such as acrylamide, are preferred.

With a view to the ease of production, it is more preferable to combine styrene (meth)acryl based hydrophilic monomers such as (meth)acrylic acid alkyl ester or (meth)acrylic acid aryl ester with monomers selected from styrene-(meth)acryl based hydrophilic monomers such as hydroxyethyl (meth)acrylate, (meth)acrylic acid polyethylene glycol monoester, (meth)acrylic acid, sulfobutyl (meth)acrylate, or acrylamide.

Polymer-coated pigments according to the present invention can be prepared employing the methods described below. For example, employed as a method in which minute pigment particles are employed as a core and a polymer shell is provided is a method described in JP-A No. 8-71405, in which pigment particles are dispersed employing polymer compounds, and after dissolving the resulting polymer compounds in organic solvents, phase inversion emulsification is carried out in water. Further listed are a method described in Shikizai Kyokaishi (Journal of the Japan Society of Color Material) 70, 503 (1997), in which after allowing monomers to adsorb on the surface of the particles, polymerization is carried out, a method described in Shikizai Kyokaishi (Journal of the Japan Society of Color Material) 69, 743 (1996), in which after introducing polymerization initiators on the surface of pigment particles, polymerization is carried out in the presence of monomers; a method in which water-soluble polymer dispersing agents are added to a water based suspension of core-forming polymers to be adsorbed; and a method in which monomers are gradually dripped, and a core is simultaneously deposited on the surface during polymerization. Alternatively, it is possible to prepare polymer-coated pigments in such a manner that pigments and polymers are kneaded, and thereafter, the resulting mixture is subjected to water-based dispersion. Further, it is possible to form a shell employing the aforesaid methods while employing the resulting polymer-coated pigments as a minute particle core.

In the present invention, a method is preferred in which monomers are gradually added to a water-based core-forming pigment suspension so that the aforesaid monomers are adsorbed on the surface of pigments, and thereafter, the resulting mixture is polymerized.

The production method of the polymer-coated pigments according to the present invention is that after forming reaction sites by adsorbing compounds having a hydrophilic portion as well as a hydrophobic portion, or protective colloids on the interface of pigments, monomers are adsorbed on the aforesaid sites, and thereafter, polymer polymerization is carried out to cover the surface of the pigment.

Production in practice is carried out employing a method in which, at the interface between the surface of pigment particles which have been finely powdered employing a conventional method and dispersion media, reaction sites capable of adsorbing monomers are previously formed by adsorbing compounds having a hydrophilic portion as well as hydrophobic portion or protective colloids, and after monomers are added to be adsorbed and fixed at the aforesaid sites, polymerization is carried out by the addition of polymerization initiators so that the surface of the pigment particles is covered by the polymers, whereby minute colored particles are produced.

In the present invention, compounds having a hydrophilic portion as well as a hydrophobic portion which form reaction sites on the surface of pigments are not particularly limited. Listed as preferable compounds are surface active agents, emulsifiers, or dispersing agents.

Listed as surface active agents usable in the present invention are, for example, cationic surface active agents such as aliphatic amine salts, aliphatic quaternary ammonium salts, benzalconium salts, benzetonium chloride, pyridinium salts, and imidazolinium salts.

Listed as anionic surface active agents are fatty acid soap, N-acyl-methylglycine salts, N-acyl-N-methyl-β-alanine salts, N-acylglutamic acid salts, alkyl ether carboxylic acid salts, acylated peptides, alkylsulfonic acid salts, alkylbenzenesulfonic acid salts, alkylnaphthalenesulfnic acid salts, dialkylsulfosuccinic acid ester salts, alkylsulfoacetic acid salts, α-olefinsulfonic acid salts, N-acylmethyltaurine, sulfonated oil, higher alcohol sulfuric acid ester salts, secondary higher alcohol sulfuric acid esters, alkyl ether sulfuric acid salts, secondary higher alcohol ethoxysulfates, polyoxyethylene alkylphenyl ether sulfuric acid salts, fatty acid alkylol sulfuric acid ester salts, alkyl ether phosphoric acid ester salts, and alkylphosphoric acid salts.

Listed as amphoteric surface active agents are carboxybetaine types, sulfobetaine types, aminocaroboxylic acid salts, and imidazolinium betaine.

Listed as nonionic surface active agents are polyoxyethylene alkyl ether, polyoxyethylene secondary alcohol ether, polyoxyethylene alkylphenyl ether (e.g. Emulgen 911), polyoxyethylene sterol ether, polyoxyethylene lanoline derivatives, polyoxyethylene polyoxypropylene alkyl ether (e.g. Newpol PE-62), polyoxyethylene glycerin fatty acid esters, polyoxyethylene castor oil, hydrogenated castor oil, polyoxyethylene sorbitan fatty acid esters, polyoxyethylene sorbitol fatty acid esters, polyethylene glycol fatty acid esters, fatty acid monoglycerides, polyglycerin fatty acid esters, sorbitan fatty acid esters, propylene glycol fatty acid esters, sucrose fatty acid esters, fatty acid alkanolamides, polyoxyethylene fatty acid amides, polyoxyethylene alkylamines, alkylamine oxides, acetylene glycol, and acetylene alcohol. Other than these, listed as surface active agents are, for example, dispersing agents Demol SNB, MS, N, SSL, ST, and P (all of which are trade names), manufactured by Kao Corp.

Further, employed as polymer surface active agents are water-soluble resins. Listed as preferably usable water-soluble resins are styrene-methacrylic acid-methacrylic acid alkyl ester copolymers, styrene-methacrylic acid copolymers, styrene-maleic acid-methacrylic acid alkyl ester copolymers, styrene-maleic acid copolymers, styrene-methacrylic acid-acrylic acid alkyl ester copolymers, styrene-methacrylic acid copolymers, styrene-maleic acid half-ester copolymers, vinylnaphthalene-methacrylic acid copolymers, and vinylnaphthalene-maleic acid copolymers. In addition, listed as examples of polymer surface active agents are Johncryl (available from Johnson Co.) which are acryl-styrene based resins. These polymer surface active agents may be employed in combinations of at least two types.

In the present invention, the used amount of surface active agents or emulsifiers is preferably 1-10,000 parts by weight with respect to 100 parts by weight of the pigments.

Further, employed as other preferable compounds which form reaction sites may be water-soluble polymers. Examples include polyvinyl alcohols such as partially saponified polyvinyl alcohol, completely saponified polyvinyl alcohol, or modified polyvinyl alcohol; cellulose derivatives such as hydroxyethyl cellulose, hydroxypropyl cellulose, or carboxymethyl cellulose; and natural polysaccharides such as gua gum. These may be employed individually or in combinations of at least two types.

In the present invention, the used amount of water-soluble polymers is preferably 1-10,000 parts by weight per 100 parts by weight of the pigments, but is more preferably 10-1,000 parts.

Polymers which cover pigments will now be described.

Monomers having a polymerizable unsaturated double bond, which adsorb the reaction sites, which are formed by adsorbing the aforesaid compounds having a hydrophilic portion as well as a hydrophobic portion, and form polymers which form shells through coverage are the compounds which are selected from monomers only having a hydrophobic portion such as ethylene, propylene, butadiene, vinyl chloride, vinylidene chloride, vinyl acetate, styrene, or (meth)acrylic acid esters. Specifically, it is preferable to combine monomers selected from monomers having only a hydrophobic group such as styrene or (meth)acrylic acid esters in which the ester portion is comprised of CH₃ to C₁₈H₃₇ with monomers selected from monomers having a hydrophilic portion such as monomers having a hydroxyl group such as hydroxyethyl (meth)acrylate, monomers having carboxylic acid such as (meth)acrylic acid, itaconic acid, or maleic acid, monomers having a sulfonic acid such as styrenesulfonic acid or sulfobutyl (meth)acrylate, and monomers having an amide group such as (meth)acrylamide.

Further, the aforesaid monomers having a hydrophilic portion include reactive emulsifiers. Listed as representative reactive emulsifiers are those represented by General Formulas (1)-(3) described below.

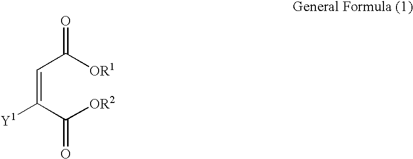

In General Formula (1), R¹ represents a straight chain alkyl group or a branched chain alkyl group having 7-20 carbon atoms and an unsubstantiated or substituted aromatic group. Examples include straight chain alkyl groups such as a heptyl group, an octyl group, a nonyl group, a decyl group, or a dodecyl group, branched chain alkyl groups such as a 2-ethyl-hexyl group, and aromatic substituents such as a phenyl group, a nonylphenyl group, or a naphthyl group, as described in aforesaid item A.

R² represents a substituent having a radically polymerizable group. Examples include an acrylate group, a methacrylate group, and a maleimide group, described in aforesaid item C. Y¹ represents sulfonic acid and carboxylic acid, and their salts.

Compounds according to the present invention, represented by General Formula (1) can be prepared by synthesis employing methods known in the prior art. Further, aforesaid compounds are commercially and readily available. For example, listed may be “Latemul S-120”, “Latemul S-120A”, Latemul S-180”, and “Latemul S-180A”, manufactured by Kao Corp., and “Ereminol JS-2”, manufactured by Sanyo Chemical Industries, Ltd.

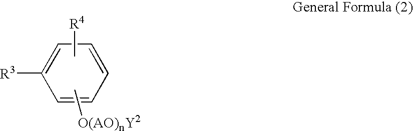

In General Formula (2), each of R³ and R⁴ is as defined for each of R¹ and R² in aforesaid General Formula (1), Y² represents a hydrogen atom, a sulfonic acid or its salts or carboxylic acid or its salts, and AO represents alkylene oxide.

Compounds according to the present invention, represented by General Formula (1), can be prepared by synthesis employing methods known in the art. Further, aforesaid compounds are commercially and readily available. For example, listed may be the NE Series such as “Adeka Reasoap NE-10”, “Adeka Reasoap NE-20”, or “Adeka Reasoap Ne-30” and the SE Series such as “Adeka Reasoap SE-10N, “Adeka Reasoap SE-20N”, or “Adeka Reasoap SE-30N”, manufactured by Asahi Denka Kogyo Co., Ltd., and the RN Series such as “Aquaron RN-10”, “Aquaron RN-20”, “Aquaron RN-30”, or “Aquaron RN-50”, HS Series such as “Aquaron HS-05”, “Aquaron HS-10”, “Aquaron HS-20”, or “Aquaron HS-30”, and Aquaron BC Series, manufactured by Dai-ichi Kogyo Seiyaku Co., Ltd.

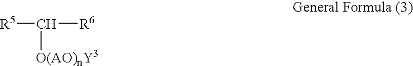

In General Formula (3), each of R⁵, R⁶, Y³, and AO is as defined for each of R¹, R², Y¹, and AO in aforesaid General Formula (1).

Compounds according to the present invention, represented by General Formula (1), can be prepared by synthesis employing methods known in the art. Further, the aforesaid compounds are commercially and readily available. For example, listed may be “Aquaron KH-05”, “Aquaron KH-10”, and “Aquaron KH-20”, manufactured by Dai-ichi Kogyo Seiyaku Co., Ltd.

In aforesaid General Formulas (2) and (3), average degree n of polymerization of the alkylene oxide chain (AO) is preferably 1-10. Listed as examples may be aforesaid “Aquaron KH-05”, “Aquaron KH-10”, “Aquaron HS-05”, and “Aquaron HS-10”.

Further, in the present invention, the reactive emulsifiers are preferably anionic. Listed as examples may be aforesaid the “Adeka Reasoap SE Series” (manufactured by Asahi Denka Kogyo Co.), the “Aquaron HS Series” (manufactured by Dai-ichi Kogyo Seiyaku Co.), the “Latemul S Series” (manufactured by Kao Corp.), and the “Ereminol JS Series” (manufactured by Sanyo Chemical Industries, Co., Ltd.).

These monomers may be added to reaction sites in the form of a previously uniformly mixed liquid composition or while varying the composition. It is preferable that initially, the surface of pigments undergoes polymerization employing a liquid monomer composition comprised of monomers having only a hydrophobic portion as a major component, and during the second half of the reaction, the monomers having a only hydrophobic portion mixed with monomers having a hydrophilic portion are added so that the surface of the pigments particles results in hydrophilicity.

Polymerization initiators employed to polymerize the aforesaid monomers are not particularly limited. Listed as examples may be various peroxides such as benzoyl peroxide, di-t-butyl peroxide, cumene hydroperoxide, t-butyl peroxide, or 2-ethylhexanoate, and various types of azo compounds such as azobisisobutyronitrile and azobisisovaleronitrile.

In the water-based ink of the present invention, polymers employed for minute colored particles are mixed with the aforesaid ink, preferably in an amount of 0.5-50 percent by weight, and more preferably in an amount of 0.5-30 percent by weight. When the aforesaid mixed amount of the polymers is less than 0.5 percent by weight, the resulting colorant protection function is not fully exhibited. On the other hand, when the aforesaid amount exceeds 50 percent by weight, the storage stability of the ink in the form of suspension degrades, and clogging of printer heads occasionally occurs due to the increase in viscosity of the ink at the tip of the nozzle, accompanied by ink evaporation and coagulation of the suspension. Consequently, it is preferable to maintain the proper mixing amounts in the aforesaid range.

In the cyan ink of the present invention, it is preferable to use water-insoluble transparent particles or water-soluble polymers together with the pigment particles according to the present invention. Further, if desired, water-insoluble transparent particles or water-soluble polymers may be employed together with the aforesaid polymer-coated dyes or polymer-coated pigments.

Water-insoluble transparent particle dispersions (hereinafter also referred to as latexes or polymer latexes) usable in the present invention are not particularly limited, and can be prepared in such a manner that, for example, vinyl based monomers are dispersed in water and the resulting dispersion undergoes emulsion polymerizations or suspension polymerization. In order to polymerize vinyl based monomers, polymerization initiators are employed. Listed as polymerization initiators are, for example, ammonium persulfate, potassium persulfate, sodium persulfate, and benzoyl peroxide. Of these, preferred is ammonium persulfate. For the purpose of improving polymerization stability, it is possible to use surface active agents as an emulsifier. In this case, it is possible to use either general nonionic type or anionic type surface active agents.

Listed as vinyl based monomers are acryl based monomers such as alkyl acrylate or alkyl methacrylate (being alkyl groups such as a methyl group, an ethyl group, an n-propyl group, an isopropyl group, an n-butyl group, an isobutyl group, a 2-ethylhexyl group, a cyclohexyl group, a phenyl group, a benzyl group, and a phenylethyl group); hydroxyl group-containing monomers such as 2-hydroxyethyl acrylate, 2-hydroxyethyl methacrylate, 2-hydroxypropyl acrylate, or 2-hydroxypropyl methacrylate; amide group-containing monomers such as acrylamide, methacrylamide, N-methylmethacrylamide, N-methylacrylamide, N-methylolacrylamide, N-methylolmethacrylamide, N,N-dimethylolacrylamide, N-methoxymethylacrylamide, N-methoxymethylmethacrylamide, or N-phenylacrylamide; amino-group containing monomers such as N,N-diethylaminoethyl acrylate or N,N-diethylaminoethyl methacrylate; epoxy group-containing monomers such as glycidyl acrylate or glycidyl methacrylate; and monomers containing a carboxyl group or its salts such as acrylic acid and methacrylic acid as well as their salts (such as sodium salts, potassium salts, or ammonium salts). Further, listed as monomers other than acryl based monomers may be, for example, epoxy group containing monomers such as allyl glycidyl ether; monomers containing a sulfonic acid group or its salts such as styrenesulfonic acid or vinylsulfonic acid, or their salts (such as sodium salts, potassium salts, or ammonium salts); monomers containing a carboxylic group or its salts such as crotonic acid, itaconic acid, maleic acid, or fumaric acid, or their salts (such as sodium salts, potassium salts, or ammonium salts); monomers containing acid anhydrides such as maleic anhydride or itaconic anhydride; vinyl isocyanate; allyl isocyanate; styrene; vinyltrisalkoxysilane; alkylmaleic acid monoesters; alkylfumaric acid monoesters; acrylonitrile; methacrylonitrile; akylintaconic acid monoesters; vinylidene chloride; vinyl acetate, vinyl chloride; and monomers having an active methylene group.

Polymer latexes may be those which are prepared by dispersing minute transparent particles employing emulsifiers or no emulsifiers. Frequently employed as emulsifiers are surface active agents. However, it is also preferable to use polymers having a water-solubilizing group such as a sulfonic acid group or a carboxylic acid group (for example, polymers in which a solubilizing group is subjected to a graft bonding or polymers which are prepared employing monomers having a solubilizing group, and monomers having an insoluble portion).

Further, in the ink according to the present invention, it is preferable-to use soap-free latexes. Soap-free latexes, as described herein, refer to latexes in which emulsifiers are not employed, as well as latexes in which polymers having a water-solubilizing group such as a sulfonic acid group or a carboxylic acid group (for example, polymers in which the solubilizing group is subjected to graft bonding, or polymers which are prepared employing monomers having a solubilizing group and monomers having an insoluble portion) are used as an emulsifier.

In recent years, as minute transparent particles in latexes, other than latexes in which polymer particles have an entirely uniform composition, there are latexes in which core/shell type polymer particles are dispersed in which the composition of the central portion is different from the peripheral portion. It is possible to preferably employ such types of latexes.

It is possible to synthesize polymer latexes employing a suitable method while referring, for example, to U.S. Pat. Nos. 3,459,790, 3,619,195, 3,929,482, and 3,700,456; West German Patent No. 2,442,165; European Patent No. 13,147; and JP-A Nos. 50-73625 and 50-146331. Further, it is possible to synthesize those employing emulsion polymerization described in JP-A Nos. 7-138304 as well as 9-302006.

On the other hand, those may be commercially available. Examples include SX8742 (thermoplastic resins are subjected to shelling on styrene-divinylbenzene cores at a particle diameter of 30 nm and solids 10 percent by weight), manufactured by JSR Co.; Nipol 1577 (acrylonitrile-butadiene, at a particle diameter of 40 nm, solids of 38 percent by weight, and a Tg of −20° C.), manufactured by Nippon Zeon Co., Ltd.; SX1503 (soap-free latex, acrylonitrile-butadiene, at a particle diameter of 65 nm, solids of 42 percent by weight, and a Tg of −20° C.), manufactured by Nippon Zeon Co., Ltd.); SX1706 (soap-free latex, acryl based, at a particle diameter of 100 nm, solids of 48 percent by weight, and a Tg of 0° C.), manufactured by Nippon Zeon Co., Ltd.; and Nipol LX811 (at a particle diameter of 110 nm and solids of 45 percent by weight), manufactured by Nippon Zeon Co.).

In the cyan ink of the present invention, the average diameter of polymer particles in the polymer latex is preferably 10-300 nm, and is more preferably 10-100 nm. When the average particle diameter of latexes exceeds 300 nm, the feeling of gloss of images degrades, while when it is less than 10 nm, water resistance as well as abrasion resistance suffers.

Water-soluble polymers according to the present invention will now be described.

Water-soluble polymers usable in the present invention are not particularly limited. Listed as one example are natural polymers. Listed as specific examples are proteins such as glue, gelatin, casein, or albumin; natural rubber such as gum Arabic or gum tragacanth; glucosides such as saponin; alginic acid and its derivatives such as alginic acid propylene glycol ester, alginic acid triethanolamine, or ammonium alginate; cellulose derivatives such as methylcellulose, carboxymethyl cellulose, hydroxyethyl cellulose, or ethyl hydroxycellulose; and shellac resins.

Further, listed as other examples of water-soluble polymers are synthetic polymers which include polyvinyl alcohols, polyvinylpyrrolidones, acryl based resins such as polyacrylic acid, acrylic acid-acrylonitrile copolymers, potassium acrylate-acrylonitrile copolymers, vinyl acetate-acrylic acid ester copolymers, or acrylic acid-acrylic acid ester copolymers, styrene-acrylic acid resins such as styrene-acrylic acid copolymers, styrene-methacrylic acid copolymers, styrene-methacrylic acid-acrylic acid ester copolymers, styrene-α-methylstyrene-acrylic acid copolymers, or styrene-α-methylstyrene-acrylic acid-acrylic acid ester copolymers, styrene-maleic acid copolymers, styrene-maleic anhydride copolymers, vinylnaphthalene-acrylic acid copolymers, vinylnaphthalene-maleic acid copolymers, and vinyl acetate based copolymers such as vinyl acetate-ethylene copolymers, vinyl acetate-fatty acid vinyl ethylene copolymers, vinyl acetate-maleic acid ester copolymers, vinyl acetate-crotonic acid copolymers, or vinyl acetate-acrylic acid copolymers and salts thereof. Of these, particularly preferred examples include compounds such as shellac resins, styrene-acrylic acid-acrylic acid ester copolymers, and polyvinylpyrrolidones, which have both hydrophobic and hydrophilic portions.

Shellac resins are classified into various grades depending on the purification method and the resultant degree of purity. Of these, are preferred those having a wax of at most two percent with respect to the resin. Further, preferred are white lac and bleached lac in which the content of dyes such as laccaic acid, erythrolaccin, or desoxyerythrolaccin is at most 0.2 percent.

In the cyan ink of the present invention, the total content of polymer components employed in pigment particles as well as water-insoluble transparent particles or water-soluble polymers is preferably at least twice the amount of colorants, is more preferably 2.0-100 times, and is still more preferably 2.0-40 times.

In the cyan ink of the present invention, it is preferable that minute colored particles are comprised of polymer-coated pigments or polymer-coated dyes. Further, in polymer-coated pigments, the amount of polymer components is preferably 0.6-10 times that of the colorants. Further, in polymer-coated dyes, the amount of polymer components is preferably 0.4-10 times that of the colorants. When the aforesaid water-insoluble transparent particles are added to these polymer-coated pigments or polymer-coated dyes, effects of the present invention are exhibited still more.

Further, in the ink set of the present invention, it is characterized that a water-based cyan ink-jet ink comprising at least pigment particles or water-insoluble colored particles is included. The aforesaid ink set is a set of a plurality of inks which are commonly employed for so-called colored ink-jet printing while employing a yellow ink, a magenta ink, and a black ink, in addition to the cyan ink of the present invention.

Still further, in the ink set of the present invention, it is preferable that at least magenta and cyan inks are comprised of two types of dark and pale inks which differ in their concentration of colorants.

In order to reproduce tone, which continuously and smoothly varies over a wide range of density, it is preferable to use an ink set comprised of two types of inks which differ in concentration of pigments. At that time, the concentration ratio between both (pale ink/dark ink) is preferably 0.5-0.1.

Colorants usable in the present invention will now be described.

Colorants usable in the present invention are not particularly limited. Specific examples which are preferably employed include, as carbon black pigments, No. 2300, No. 900, MCF-88, No. 33, No. 40, No.45, No.52, MA7, MA8, MA100, and No. 2200B, all the above manufactured by Mitsubishi Chemical Corp., Ltd.; Raven 700, Raven 5750, Raven 5250, Raven 5000, Raven 3500, and Raven 1255, all the above are manufactured by Columbia Co.; Regal 400R, Regal 330R, Regal 660R, Mogul L, Monarch 700, Monarch 800, Monarch 880, Monarch 900, Monarch 1000, Monarch 1100, Monarch 1300, and Monarch 1400, all the above are manufactured by Cabot Co.; Color Black FW1, Color Black FW2, Color Black FW2V, Color Black FW18, Color Black FW200, Color Black S150, Color Black S160, Color Black S170, Printex 35, Printex U, Printex V, Printex 140U, Printex 140V, Special Black 6, Special Black 5, Special Black 4A, and Special Black 4, all the above are manufactured by Degussa Corp.; and Maxsorb B-40, Maxsorb G-15, and Maxsorb G-08, all the above are manufactured by Kansai Netsukagaku Co., Ltd.

Listed as yellow pigments are C.I. Pigment Yellow 1, C.I. Pigment Yellow 2, C.I. Pigment Yellow 3, C.I. Pigment Yellow 12, C.I. Pigment Yellow 13, C.I. Pigment Yellow 14, C.I. Pigment Yellow 16, C.I. Pigment Yellow 17, C.I. Pigment Yellow 73, C.I. Pigment Yellow 74, C.I. Pigment Yellow 75, C.I. Pigment Yellow 83, C.I. Pigment Yellow 93, C.I. Pigment Yellow 95, C.I. Pigment Yellow 97, C.I. Pigment Yellow 98, C.I. Pigment Yellow 114, C.I. Pigment Yellow 128, C.I. Pigment Yellow 129, C.I. Pigment Yellow 151, C.I. Pigment Yellow 154, and C.I. Pigment Yellow 180.

Listed as magenta pigments are C.I. Pigment Red 5, C.I. Pigment Red 7, C.I. Pigment Red 12, C.I. Pigment Red 48 (ca), C.I. Pigment Red 48 (Mn), C.I. Pigment Red 57 (ca), C.I. Pigment Red 57: 1, C.I. Pigment Red 112, C.I. Pigment Red 122, C.I. Pigment Red 168, C.I. Pigment Red 184, and C.I. Pigment Red 202.

Listed as cyan pigments are C.I. Pigment Blue 1, C.I. Pigment Blue 2, C.I. Pigment Blue 3, C.I. Pigment Blue 15: 3, C.I. Pigment Blue 15; 34, C.I. Pigment Blue 16, C.I. Pigment Blue 22, C.I. Pigment Blue 60, C.I. Vat Blue 4, and C.I. Vat Blue 60.

Further, dyes usable in the present invention are not particularly limited. Listed as specific preferred examples are Valifast Yellow 4120, Valifast Yellow 3150, Valifast Yellow 3108, Valifast Yellow 2310N, Valifast Yellow 1101, Valifast Red 3320, Valifast Red 3304, Valifast Red 1306, Valifast Blue 2610, Valifast Blue 2606, Valifast Blue 1603, Oil Yellow GG-S, Oil Yellow 3G, Oil Yellow 129, Oil Yellow 107, Oil Yellow 105, Oil Scarlet 308, Oil Red RR, Oil Red OG, Oil Red 5B, Oil Pink 312, Oil Blue BOS, Oil Blue 613, Oil Blue 2N, Oil Black BY, Oil Black BS, Oil Black 860, Oil Black 5970, Oil Black 5906, and Oil Black 5905, all the above are manufactured by Orient Chemical Industries, Ltd.; Kayaset Yellow SF-G, Kayaset Yellow K-CL, Kayaset Yellow GN, Kayaset Yellow A-G, Kayaset Yellow 2G, Kayaset Red SF-4G, Kayaset Red K-BL, Kayaset Red A-BR, Kayaset Magenta 312, and Kayaset Blue K-FL, all the above are manufactured by Nippon Kayaku Co., Ltd.; FS Yellow 1015, FS Magenta 1404, FS Cyan 1522, FS Blue 1504, C.I. Solvent Yellow 88, Solvent Yellow 83, Solvent Yellow 82, Solvent Yellow 79, Solvent Yellow 56, Solvent Yellow 29, Solvent Yellow 19, Solvent Yellow 16, Solvent Yellow 14, Solvent Yellow 04, Solvent Yellow 03, Solvent Yellow 02, Solvent Yellow 01, C.I. Solvent Red 84: 1, C.I. Solvent Red 84, C.I. Solvent Red 218, C.I. Solvent Red 132, C.I. Solvent Red 73, C.I. Solvent Red 72, C.I. Solvent Red 51, C.I. Solvent Red 43, C.I. Solvent Red 27, C.I. Solvent Red 24, Solvent Red 18, Solvent Red 01, Solvent Blue 70, Solvent Blue 67, Solvent Blue 44, Solvent Blue 40, Solvent Blue 35, Solvent Blue 11, Solvent Blue 02, Solvent Blue 01, Solvent Black 43, C.I. Solvent Black 70, C.I. Solvent Black 34, C.I. Solvent Black 29, C.I. Solvent Black 27, C.I. Solvent Black 22, C.I. Solvent Black 7, C.I. Solvent Black 3, C.I. Solvent Violet 3, as well as C.I. Solvent Green and 7, all the above are manufactured by Arimoto Chemical Industry Co., Ltd.

Further, preferably employed are the metal complex dyes described in JP-A Nos. 9-277693, 10-20559, and 10-30061. Preferred structures are represented by General Formula (A) described below.

M(Dye)₁(A)ₘ General Formula [A]

wherein M represents a metal ion; Dye represents a dye capable of forming a coordinate bond with metal; A represents a ligand except for dyes; 1 represents 1-3; and m represents 0, 1, 2, or 3. When m is 0, 1 represents 1, 2, or 3. In such a case, Dye may be the same or different. Listed as metal ions represented by M are, for example, Al, Co, Cr, Cu, Fe, Mn, Mo, Ni, Sn, Ti, Pt, Pd, Zr and Zn ions. Of these, in view of tone and various types of durability, Ni, Cu, Cr, Co, Zn, and Fe ions are particularly preferred. Of these, Ni ions are more preferred.

Considered as dyes capable of forming a coordinate bond with the metal represented by Dye may be various dye structures. Of these, preferred are dyes which have a ligand in the skeleton of conjugated methane dyes, azomethine dyes, or azo dyes.

Disperse dyes are not limited to those below. Listed as particularly preferred specific examples are C.I. Disperse Yellow 5, 42, 54, 67, 79, 82, 83, 93, 99, 100, 119, 122, 124, 126, 160, 184: 1, 186, 198, 199, 204, 224, and 237; C.I. Disperse Orange 13, 29, 31: 1, 33, 49, 55, 66, 73, 118, 119, and 163; C.I. Disperse Red 54, 60, 72, 73, 86, 88, 91, 92, 93, 111, 126, 127, 134, 135, 143, 145, 152, 153, 154, 159, 164, 167: 1, 177, 181, 204, 206, 207, 221, 239, 240, 258, 277, 278, 283, 311, 323, 343, 348, 356, and 362; C.I. Disperse Violet 33; C.I. Disperse Blue 56, 60, 73, 87, 113, 128, 143, 148, 154, 158, 165, 165: 1, 165: 2, 176, 183, 185, 197, 198, 201, 214, 224, 225, 257, 266, 267, 287, 354, 358, 365, and 368; and C.I. Disperse Green 6: 1, and 9.

Further, dyes represented by General Formulas (A)-(C) below can preferably be employed.

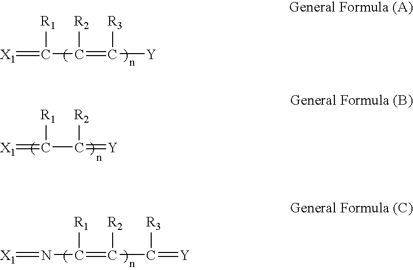

In aforesaid General Formulas (A)-(C), X₁ represents a coupler residue employed in silver halide light-sensitive color photographic materials. Preferably listed are acetanilide, 5-pyrazolone, imidazole, pyrazolopyrrole, pyrazoloimidazole, pyrazolotriazole, pyrazolotetrazole, pyrazolopyrimidine-7-one, barbituric acid, thiobarbituric acid, rhodanine, hydantoin, thiohydantoin, oxazolone, isooxazolone, indandione, pyrazolidinedione, oxazolidinedione, hydroxypyridone, pyrazolopyridone, cyclohexadienone, phenol and naphthol derivatives, while n represents 0, 1, or 2.

Y represents a 5- or 6-membered aromatic carbon ring group or a heterocyclic group, and preferably represents benzene, pyridine, pyrrole, thiazole, oxazole, furan, and thiophene derivatives.

R₁, R₂, and R₃ each represent a hydrogen and a univalent substituent, and examples of the univalent substituents represented by R₁, R₂, and R₃ include an alkyl group, a cycloalkyl group, an aralkyl group, an aryl group, an alkoxy group, an aryloxy group, an acylamino group, a sulfonamide group, a ureido group, an alkoxycarbonylamino group, an alkylthio group, an arylthio group, an alkoxycarbonyl group, a carbamoyl group, a sulfamoyl group, a sulfonyl group, and an amino group.

Colorants incorporated into pigments particles or minute colored particles according to the present invention are blended in ink preferably in an amount of 1-30 percent by weight and more preferably in an amount of 1.5-25 percent by weight. When the blended amount of the aforesaid colorants is at most one percent by weight, printing density is insufficient, while when the blended amount exceeds 30 percent by weight, the storage stability of the resulting suspension is degraded tending to result in an increase in particle diameter due to aggregation. Consequently, it is preferable to control the blended amount within the aforesaid range.

The cyan ink as well as each colored ink employed in the ink set of the present invention is comprised of a polymer suspension in which water is used as a medium and each of the aforesaid colorants is sealed, and into the aforesaid suspension incorporated may be water-based solvents (for example, humectants such as polyhydric alcohols), dispersing agents, silicone based defoamers, chloromethylphenol based mildewcides and/or chelating agents such as EDTA, and oxygen absorbing agents such as sulfites.

Water-based solvents, as described in the present invention, are not particularly limited, but water-soluble organic solvents are preferred. Specifically listed are alcohols (for example, methanol, ethanol, propanol, isopropanol, butanol, isobutanol, secondary butanol, tertiary butanol, pentanol, hexanol, cyclohexanol, and benzyl alcohol); polyhydric alcohols (for example, ethylene glycol, diethylene glycol, triethylene glycol, polyethylene glycol, propylene glycol, dipropylene glycol, polypropylene glycol, butylene glycol, hexanediol, pentanediol, glycerin, hexanetriol, and thioglycol); polyhydric alcohol ethers (for example, ethylene glycol monomethyl ether, ethylene glycol monomethyl ether, ethylene glycol monobutyl ether, ethylene glycol monophenyl ether, diethylene glycol monomethyl ether, diethylene glycol monomethyl ether, diethylene glycol monobutyl ether, diethylene glycol methyl ether, propylene glycol monomethyl ether, propylene glycol monobutyl ether, ethylene glycol monomethyl ether acetate, triethylene glycol monomethyl ether, triethylene glycol monomethyl ether, triethylene glycol monobutyl ether, triethylene glycol dimethyl ether, dipropylene glycol monopropyl ether, and tripropylene glycol dimethyl ether); amines (for example, ethanolamine, diethanolamine, triethanolamine, N-methyldiethanolamine, N-ethyldiethanolamine, morpholine, N-ethylmorpholine, ethylenediamine, diethylenediamine, pentamethyldiethylenetriamine, and tatramethylpropylenediamine); amides (for example, formamide, N,N-dimethylformamide, and N,N-dimethylacetamide), heterocycles (for example, 2-pyrrolidone, N-methyl-2-pyrrolidone, N-cyclohexyl-2-pyrrolidone, 2-oxazolidone, and 1,3-dimethyl-2-imidazolidinone); sulfoxides (for example, sulfolane); and sulfonic acid salts (for example, sodium 1-butanesulfonate), urea, acetonitrile, and acetone.

At least one of each of the anionic surface active agents, the nonionic surface active agents, and the cationic surface active agents can be used in the cyan ink as well as in each colored ink employed in the ink set of the present invention. Surface active agents usable in the present invention are not particularly limited, and examples include anionic surface active agents such as dialkylsulfosuccinic acid salts, alkylnaphthalenesulfonic acid salts, or fatty acid salts, nonionic surface active agents such as polyoxyethylene alkyl ethers, polyoxyethylene alkyl allyl ethers, acetylene glycols, or polyoxyethylene-polyoxypropylene block polymers, and cationic surface active agents such as alkylamine salts or quaternary ammonium salts.

Further, polymer surface active agents can be used in the cyan ink as well as in each colored ink employed in the ink set of the present invention. Examples include styrene-acrylic acid-alkyl acrylate copolymers, styrene-acrylic acid copolymers, styrene-maleic acid-alkyl acrylate copolymers, styrene-maleic acid copolymers, styrene-methacrylic acid-alkyl acrylate copolymers, styrene-methacrylic acid copolymers, styrene-maleic acid half ester copolymers, vinylnaphthalene-acrylic acid copolymers, and vinylnaphthalene-maleic acid copolymers.

Still further, dispersing agents are not particularly limited. However, their HLB values are preferably 8-18, since effects as the dispersing agents are exhibited and the increase in the particle diameter in suspension is effectively minimized.

Commercially available dispersing agents can be employed. Examples of major commercially available dispersing agent products include, Demol SNB, MS, N, SSL, ST, and P (all these are trade names), manufactured by Kao Corp.

The blending ratio of dispersing agents is not particularly limited. However, it is preferable that dispersing agents are blended in the water-based ink of the present invention in an amount of 0.01-10 percent by weight. When the blending ratio of the aforesaid compounds is less than 0.01 percent by weight, it becomes difficult to prepare particles at a smaller diameter in suspension. On the other hand, when the aforesaid blending ratio exceeds 10 percent by weight, the particle diameter in the suspension increases or the stability of the suspension is degraded, whereby undesirable gelling may occur. Consequently, it is preferable to maintain the blending ratio within the aforesaid range.

Further, defoamers are not particularly limited and it is possible to use commercially available products. Listed as such commercially available products are, for example, KF96, 66, and 69, KS68, 604, 607A, 602, and 603, and KM73, 73A, 73E, 72, 72A, 72C, 72F, 82F, 70, 71, 75, 80, 83A, 85, 89, 90, 68-1F, and 68-2F (all are trade names), manufactured by Shin-Etsu Silicone Co. The blending ratio of these compounds is not particularly limited, but it is preferable that these compounds are blended in the pigments particles or minute colored particle containing water-based ink of the present invention in an amount of 0.001-2 percent by weight. When the blending ratio of the aforesaid compounds is less than 0.001 percent by weight, foam tends to be generated during ink preparation and it becomes difficult to remove all traces of foam in the ink. When the aforesaid blending ratio exceeds 2 percent by weight, foam formation is minimized, but print quality is occasionally degraded due to formation of repellency in the ink during printing. As a result, it is preferable to maintain the blending ration within the aforesaid range.

If desired, other than those described above, in response to the purposes to enhance various properties such as ejection stability, print head and ink cartridge adaptability, storage stability, and image storage stability, employed in the cyan ink and in each ink employed in the ink set of the present invention may be various suitably selected prior art additives such as viscosity modifiers, specific resistance controlling agents, layer forming agents, UV absorbers, antioxidants, anti-discoloring agents, mildewcides, or corrosion inhibitors. Examples of these additives include liquid paraffin, dioctyl phthalate, tricresyl phosphate, minute oil droplets such as silicone oil, UV absorbers described in JP-A Nos. 57-74193, 57-87988, and 62-261476, anti-discoloring agents described in JP-A Nos. 57-74192, 57-87989, 60-72785, 61-146591, 1-95091, and 3-13376, and optical brightening agents described in JP-A Nos. 59-42993, 59-52689, 62-280069, 61-242871, and 4-219266.

Ink-jet recording media employed in the present invention are characterized of comprising a porous layer. When combined with the ink of the present invention, the effects of the present invention are most exhibited.

Listed as specific examples of porous ink-jet recording media are porous ink-jet paper sheets or porous ink-jet films. These are recording media in which an ink absorbable void layer is provided, and the void layer is formed mainly by employing soft aggregation of hydrophilic binders with minute inorganic particles.

Various methods are known for forming voids in a layer. Examples include a method in which a uniform liquid coating composition comprising at least two polymers is applied onto a support in which voids are formed in such a manner that these polymers are subjected to mutual phase separation during the drying process; a method in which a liquid coating composition comprising minute solid particles as well as hydrophilic or hydrophobic binders is applied onto a support, and after drying, the resulting ink-jet recording sheet is immersed in water or liquid comprising suitable organic solvents to dissolve the minute solid particles, whereby voids are formed; a method in which after coating a liquid coating composition comprising compounds which generate bubbles during formation of the layer, voids are formed by allowing the aforesaid compounds to generate bubbles during the drying process; a method in which a liquid coating composition comprising minute porous solid particles and hydrophilic binders is applied onto a support, and voids are formed in the minute porous solid particles or among minute particles; and a method in which a liquid coating composition comprising minute solid particles and/or minute oil droplets having a volume slightly more than the hydrophilic binders as well as the hydrophilic binders are applied onto a support, and voids are formed among the minute solid particles. When the ink of the present invention is used, provided void layers employing any of these methods exhibit desired results.

Employed as ink-jet heads usable in the image forming method of the present invention may be those utilizing either on-demand systems or continuous systems. Further, listed as specific examples of projection systems may be an electrical-mechanical conversion systems (for example, a single cavity type, a double cavity type, a vendor type, a piston type, a share mode type, and a shared wall type); an electricity-heat conversion system (for example, a thermal ink-jet type and a bubble jet (R) type); and an electrostatic suction system (for example, an electric field control type and a slit jet type), and a discharge system (for example, a spark jet type). Any of these ejection systems may be employed.

### EXAMPLES

The present invention will now be described with reference to examples, but the present invention is not limited thereto.

### Example 1

### <<Preparation of Pigment Dispersion: Type A>>

(Preparation of Pigment Dispersion A-1)

After mixing 166 g of C.I. Pigment Blue 15: 3, 32 g of a polymer dispersing agent (styrene/2-ethylhexyl acrylate/n-butyl acrylate/styrenesulfonic acid=64/16/15/5), 180 g of diethylene glycol, and 1,000 g of ion-exchange water, the resulting mixture was dispersed employing a horizontal type bead mill (System-Zetamini, manufactured by Ashizawa Co.) incorporating 0.3 mm zirconia beads at a volume ratio of 60 percent. Subsequently, the resulting dispersion was diluted by the addition of ion-exchange water to reach a pigment concentration of 5 percent by weight. Thereafter, impurities, as well as the polymer dispersing agent which had not been adsorbed, were removed employing ultrafiltration. Thereafter, the resulting dispersion was subjected to an ion exchange treatment and coarse particles were removed employing centrifugal separation to obtain uniform diameter particles, whereby Pigment Dispersion A-1 was prepared. The volume average diameter of the pigment particles contained in aforesaid Pigment Dispersion A-1 was determined to be 52 nm employing a Zeta Sizer 1000, manufactured by Malvern Inc. Further, the amount of the polymer components incorporated into aforesaid Pigment Dispersion A-1 was 1.7 percent by weight.

(Preparation of Pigment Dispersions A-2, A-3, and A-4)

Pigment Dispersion A-2 exhibiting a volume average pigment particle diameter of 42 nm, Pigment Dispersion A-3 exhibiting a volume average pigment particle diameter of 58 nm, and Pigment Dispersion A-3 exhibiting a volume average pigment particle diameter of 100 nm were prepared in the same manner as aforesaid Pigment Dispersion A-1, except that the dispersing conditions (frequency of revolution) were suitably controlled.

(Preparation of Pigment Dispersion A-5)

Pigment Dispersion A-5 exhibiting a volume average pigment particle diameter of 58 nm was prepared in the same manner as aforesaid Pigment Dispersion A-1, except that coarse particles were not removed by centrifugal separation.

### <<Preparation of Polymer-coated Dye Dispersion: Type B>>

(Preparation of Polymer-Coated Dye Dispersion B-1)

Placed in a separable flask were 3.57 g of polyvinyl butyral (BL-1 at an average degree of polymerization of 350, manufactured by Sekisui Chemical Co., Ltd.), 5.0 g of a cyan dye (C.I. Solvent Blue 70), and 50 g of ethyl acetate. After replacing air in the flask with nitrogen gas, while stirring, the aforesaid polyvinyl butyral and cyan dye were completely dissolved. Subsequently, 100 g of an aqueous solution containing 2.0 g of sodium dodecybenzenesulfonate was dripped into it. After stirring, the resulting mixture was emulsified for 300 seconds employing an ultrasonic homogenizer (Type UH-150, manufactured by SMT Co., Ltd.). Thereafter, ethyl acetate was removed under vacuum, whereby dye impregnating core type minute colored particle dispersion was prepared.

Subsequently, a shell forming process was carried out as follows. The interior of the flask in which the aforesaid core type minute colored particle dispersion was placed was filled with nitrogen gas. Thereafter, 0.15 g of potassium persulfate was added to the aforesaid minute colored particle dispersion and dissolved. The resulting mixture was heated to 70° C., employing an attached heater. Subsequently, over 5 minutes was dripped 1.43 g of a mixed liquid composition of styrene/2-hydroxyethyl methacrylate (at a mol ratio of 4/1), and the resulting mixture underwent reaction for 7 hours, whereby shells were formed. The resulting dispersion was purified employing ultrafiltration and an operation for removing coarse particles was then carried out employing centrifugal separation, whereby core/shell type Polymer-coated Dye Dispersion B-1, containing a cyan dye in an amount of 5.0 percent by weight, was prepared. The volume average diameter of minute colored particles contained in Polymer-coated Dye Dispersion. B-1 was 40 nm. Further, the amount of polymer components contained in aforesaid Polymer-coated Dye Dispersion B-1 was 5.0 percent by weight.

(Preparation of Polymer-coated Dye Dispersions B-2-B-5)

Polymer-coated Dye Dispersions B-2-B-5 in which the amount of polymer components contained in the polymer-coated dispersion was 1.67 g, 8.33 g, 15.0 g and 20 g, respectively, were prepared in such a manner that, in the preparation of aforesaid Polymer-coated Dye Dispersion B-1, the used ratio of polyvinyl butyral to styrene/2-hydoxyethyl methacrylate was kept constant but the addition amount was suitably varied.

(Preparation of Polymer-coated Dye Dispersion B-6)

Cyan dye containing core/shell type Polymer-coated Dye Dispersions B-6 was prepared in the same manner as aforesaid Polymer-coated Dye Dispersion B-1, except that the added amount of sodium dodecybenzenesulfonate was varied to 1.0 g. The volume average diameter of the minute colored particles contained in aforesaid Polymer-coated Dye Dispersion B-6 was 100 nm. Further, the amount of polymer components contained in aforesaid Polymer-coated Dye Dispersion B-6 was 5.0 percent by weight.

(Preparation of Polymer-coated Dye Dispersion B-7)

Polymer-coated Dye Dispersion B-7 was prepared in the same manner as aforesaid Polymer-coated Dye Dispersion 1, except that the operation for removing coarse particles employing centrifuhal separation was not carried out.

### <<Preparation of Polymer-coated Dye Dispersion: Type C>>

(Preparation of Polymer-coated Pigment Dispersion C-1)

Fourteen g of a water dispersion (at a pigment concentration of 10 percent by weight), which had been prepared by dispersing C.I. Pigment blue 15: 3 in sodium bis2-ethylhexylsulfosuccinate was collected and added to 200 ml of ion-exchange water. The resulting mixed liquid composition was placed in a 200 ml interior volume cylindrical separable flask fitted with a thermal sensor, a nitrogen inletting pipe and a stirrer.

Subsequently, under a flow of nitrogen, added to the aforesaid mixed liquid composition were 2.0 g of sodium dodecylsulfate and 0.4 g of a styrene monomer. After stirring at room temperature for one hour, the interior temperature was slowly raised to 70° C. When the interior temperature reached 70° C., was dripped 10 ml of an aqueous solution in which 0.1 g of potassium persulfate was dissolved. Subsequently, over 6 hours was gradually dripped 1.4 g of styrene monomer. After that dripping, over 2 hours was gradually dripped 0.4 g of the mixed monomer of styrene/methacrylic acid (at a weight ratio of 1/1) and the resulting mixture was stirred for an additional two hours, whereby shelling on the surface of pigments particle employing polymers was complete. Subsequently, the resulting liquid reaction composition was cooled and its pH was adjusted to 8.2 by the addition of a 0.2 percent aqueous sodium hydroxide solution. Then concentration as well as purification was carried out employing an ultrafiltration apparatus so that the pigment concentration reached 10 percent by weight. Thereafter, coarse particles were removed by a centrifugal separation process, whereby Polymer-coated Pigment Dispersion C-1 was prepared in which the surface of pigment particles was covered by the polymers. The volume average diameter of the pigment particles incorporated into resulting Polymer-coated Pigment Dispersion C-1 was 40 nm. Further, the amount of the polymer components incorporated into aforesaid Polymer-coated Pigment Dispersion C-1 was 10 percent by weight.

(Preparation of Polymer-coated Pigment Dispersion C-2)

Polymer-coated Dispersion C-2 in which the surface of the pigment particles was covered by polymers was prepared in the same manner as aforesaid Polymer-coated Dispersion C-1, except that the added amount of sodium dodecylsulfate was varied to 1.8 g. The volume average diameter of pigment particles contained in aforesaid Polymer-coated Pigment Dispersion C-2 was 62 nm. Further, the amount of the polymer components contained in aforesaid Polymer-coated Pigment Dispersion C-1 was 10.0 percent by weight.

(Preparation of Polymer-coated Pigment Dispersions C-3-C-5)

Polymer-coated Pigment Dispersions C-3-C-5 in which the amounts of the polymer components contained in each of the polymer-coated pigment dispersion were 3.33 percent by weight, 16.7 percent by weight, and 30.0 percent by weight, respectively, were prepared in the same manner as aforesaid Polymer-coated Pigment Dispersion C-2, except that while maintaining the used ratio of the styrene monomer to the mixed monomer of styrene/methacrylic acid (at a weight ratio of 1/1) at a constant level, their addition amount was suitably varied.

(Preparation of Polymer-coated Pigment Dispersion C-6)

Polymer-coated Pigment Dispersion C-6 in which the surface of the pigment particles was covered by polymers was prepared in the same manner as aforesaid Polymer-coated Pigment Dispersion C-2, except that while maintaining the used ratio of the styrene monomer to the mixed monomer of styrene/methacrylic acid (at a weight ratio of 1/1) at a constant level, their addition amount was suitably varied and the added amount of sodium dodecylsulfate was varied to 1.5 g. The volume average diameter of pigment particles contained in aforesaid Polymer-coated Pigment Dispersion C-6 was 70 nm. Further, the amount of the polymer components contained in aforesaid Polymer-coated Pigment Dispersion C-6 was 40.0 percent by weight.

(Preparation of Polymer-coated Pigment Dispersion C-7)

Polymer-coated Dispersion C-7 in which the surface of the pigment particles was covered by polymers was prepared in the same manner as aforesaid Polymer-coated Dispersion C-2, except that sodium dodecylsulfate was replaced with sodium benzenesulfonate. The volume average diameter of pigment particles contained in aforesaid Polymer-coated Pigment Dispersion C-7 was 100 nm. Further, the amount of the polymer components contained in aforesaid Polymer-coated Pigment Dispersion C-7 was 10.0 percent by weight.

(Preparation of Polymer-coated Pigment Dispersion C-8)

Polymer-coated Dispersion C-8 was prepared in the same manner as aforesaid Polymer-coated Dispersion C-2, except that a coarse particle removal process, employing a centrifugal separation, was not carried out.

### <<Preparation of Cyan Inks>>

Cyan Inks 1-48, which were constituted as described in Table 1, were prepared employing Pigment Dispersions A-1-A-6, Polymer-coated Dye Dispersions B-1-B-7, and Polymer-coated Pigment Dispersions C-1-C-8.

Codes in Table 1 are detailed as follows. P-1: shellac resin (SA-25 at a solid of 25 percent by weight, manufactured by Japan Shellac Industries Ltd.) P-2: water-based acrylic resin (Hitech 532, manufactured by Japan Shellac Industries, Ltd.)

(Preparation of LX-1)

Preparation was carried out based on the method below.

A mixture consisting of 600 ml of distilled water, 2.6 g of sodium dodecylsulfate, 0.34 g of formaldehyde sodium sulfoxylate dihydrate, and 0.001 g of ferric sulfate heptahydrate was placed under a flow of nitrogen in a 1 L separable flask fitted with a stirrer, a reflux cooler, and a dripping funnel maintained at 50° C. Subsequently, while stirring, a mixture consisting of 31.2 g of styrene (St), 42.0 g of n-butyl methacrylate (BMA), 25.5 g of 2-hyroxyethyl methacrylate (HEMA), and 0.5 g of cumenehydroperoxide was dripped into the above mixture over two hours to result in emulsification, whereby an emulsion was prepared.

The resulting emulsion was subjected to ultrafiltration and centrifugal separation, whereby latex dispersion LX-1 at an average particle diameter of 25 nm and a concentration of 25 percent by weight was prepared.

Incidentally, the polymer composition of LX-1 was St/BMA/MAA=30/30/30 in terms of mol ratio.

(Preparation of LX-2 and LX-3)

LX-2 and LX-3 at an average particle diameter of 50 nm and 100 nm, respectively, were prepared in the same manner as aforesaid LX-1, except that the added amount of sodium dodecylsulfate was suitably controlled.

(Preparation of LX-4)

LX-4 was prepared in the same manner as aforesaid LX-1, except that the monomer composition was varied to St/BMA/MAA (methacrylic acid)=40/20/20 in terms of mol ratio.

(Ink Solvent Composition)

(Ink Solvent Composition A)

Each of the dispersions and each of the polymer additives, described in Table 1, were added. Subsequently, the ink solvents comprised as described below were added. Finally, pure water was added to make 100 percent by weight.

| | |
|---|---|
| Ethylene glycol | 10 weight percent |
| Triethylene glycol monobutyl | 10 weight percent |
| ether | |
| Olfin E1010 (manufactured by | 0.3 weight percent |
| Nissin Chemical Industry | |
| Co., Ltd.) | |
| Proxel GXL (manufactured by Avecia | 0.3 weight percent |
| Corp.) | |

(Ink Solvent Composition B)

Each of the dispersions and each of the polymer additives, described in Table 1, were added. Subsequently, the ink solvents comprised as described below were added. Finally, pure water was added to make 100 percent by weight.

| | |
|---|---|
| Diethylene glycol | 10 weight percent |
| 1,2-Hexanediol | 10 weight percent |
| Glycerin | 5 weight percent |
| Olfin E1010 (manufactured by | 0.3 weight percent |
| Nissin Chemical Industry | |
| Co., Ltd.) | |
| Proxel GXL (manufactured by Avecia | 0.3 weight percent |
| Corp.) | |

(Determination of Particle diameter Distribution Value)

The volume particle diameter distribution of each cyan ink was determined employing a Zeta Sizer 1000, manufactured by Malvern Instruments Inc., and based on the aforesaid method, the integral curve of distribution function dG=F(D)×dD(G) (where G is the number of water-insoluble minute colored particle and D is the particle diameter) was prepared. Based on the resulting curve, D₁₀, D₅₀, and D₉₀ were determined, and polydispersity index Y was calculated based on [(D₉₀-D₁₀)/D₅₀].

TABLE 1

| | | | | Polymer | | | Particle Size | | | |
|---|---|---|---|---|---|---|---|---|---|---|
| Cyan | | Polymer | Colorant | Component | | Ink | Distribution Value | | | |
| Ink | Dispersion | Additive | Concentration | Dispersion | (*P) | Solvent | D₁₀ | D₅₀ | D₉₀ | Polydispersity |
| No. | No. | (*P) | weight % | weight % | weight % | Composition | (nm) | (nm) | (nm) | Index |
| 1 | A-1 | — | 3.0 | 1.0 | — | A | 34 | 52 | 89 | 1.06 |
| 2 | A-1 | P-1 | 3.0 | 1.0 | 1.0 | A | 34 | 52 | 89 | 1.06 |
| 3 | A-1 | P-1 | 3.0 | 1.0 | 3.0 | A | 34 | 52 | 89 | 1.06 |
| 4 | A-1 | P-1 | 3.0 | 1.0 | 7.0 | A | 34 | 52 | 89 | 1.06 |
| 5 | A-1 | P-2 | 3.0 | 1.0 | 7.0 | A | 32 | 55 | 92 | 1.09 |
| 6 | A-1 | P-1 | 1.0 | 0.3 | 3.0 | A | 35 | 53 | 88 | 1.00 |
| 7 | A-1 | P-1 | 3.0 | 1.0 | 7.0 | B | 34 | 53 | 92 | 1.09 |
| 8 | A-1 | P-1 | 3.0 | 1.0 | 11.0 | A | 34 | 52 | 89 | 1.06 |
| 9 | A-3 | P-1 | 3.0 | 1.0 | 11.0 | A | 32 | 58 | 126 | 1.62 |
| 10 | A-4 | P-1 | 3.0 | 1.0 | 6.0 | A | 50 | 102 | 160 | 1.08 |
| 11 | A-2 | LX-1 | 3.0 | 1.0 | 6.0 | A | 12 | 32 | 70 | 1.81 |
| 12 | A-1 | LX-2 | 3.0 | 1.0 | 3.0 | A | 34 | 54 | 90 | 1.04 |
| 13 | A-1 | LX-2 | 3.0 | 1.0 | 6.0 | A | 30 | 52 | 85 | 1.06 |
| 14 | A-1 | LX-2 | 3.0 | 1.0 | 8.0 | A | 28 | 50 | 84 | 1.12 |
| 15 | A-1 | LX-4 | 3.0 | 1.0 | 8.0 | A | 32 | 48 | 92 | 1.25 |
| 16 | A-1 | LX-2 | 1.0 | 0.3 | 3.0 | A | 30 | 51 | 88 | 1.14 |
| 17 | A-1 | LX-2 | 3.0 | 1.0 | 8.0 | B | 32 | 48 | 90 | 1.21 |
| 18 | A-1 | LX-2 | 3.0 | 1.0 | 11.0 | A | 25 | 48 | 82 | 1.19 |
| 19 | A-5 | LX-2 | 3.0 | 1.0 | 11.0 | A | 25 | 58 | 128 | 1.78 |
| 20 | A-1 | LX-3 | 3.0 | 1.0 | 6.0 | A | 34 | 74 | 140 | 1.43 |
| 21 | A-4 | LX-2 | 3.0 | 1.0 | 6.0 | A | 28 | 73 | 168 | 1.92 |
| 22 | B-2 | — | 3.0 | 1.0 | — | A | 22 | 39 | 70 | 1.23 |
| 23 | B-1 | — | 3.0 | 3.0 | — | A | 18 | 41 | 76 | 1.42 |
| 24 | B-3 | — | 3.0 | 5.0 | — | A | 22 | 43 | 74 | 1.21 |
| 25 | B-4 | — | 1.0 | 3.0 | — | A | 24 | 40 | 69 | 1.13 |
| 26 | B-3 | — | 3.0 | 5.0 | — | B | 24 | 46 | 73 | 1.07 |
| 27 | B-5 | — | 3.0 | 12.0 | — | A | 26 | 54 | 78 | 0.96 |
| 28 | B-7 | — | 3.0 | 3.0 | — | A | 18 | 52 | 120 | 1.96 |
| 29 | B-6 | — | 3.0 | 3.0 | — | A | 58 | 98 | 158 | 1.02 |
| 30 | B-1 | LX-1 | 3.0 | 3.0 | 2.0 | A | 15 | 30 | 65 | 1.67 |
| 31 | B-1 | LX-2 | 3.0 | 3.0 | 2.0 | A | 22 | 44 | 85 | 1.43 |
| 32 | B-1 | LX-2 | 3.0 | 3.0 | 6.0 | A | 24 | 45 | 85 | 1.36 |
| 33 | B-1 | LX-3 | 3.0 | 3.0 | 2.0 | A | 26 | 57 | 140 | 2.00 |
| 34 | B-6 | LX-2 | 3.0 | 3.0 | 2.0 | A | 25 | 63 | 142 | 1.86 |
| 35 | C-1 | — | 3.0 | 3.0 | — | A | 15 | 40 | 87 | 1.80 |
| 36 | C-3 | — | 3.0 | 1.0 | — | A | 43 | 67 | 100 | 0.85 |
| 37 | C-2 | — | 3.0 | 3.0 | — | A | 45 | 62 | 93 | 0.77 |
| 38 | C-4 | — | 3.0 | 5.0 | — | A | 40 | 63 | 103 | 1.00 |
| 39 | C-5 | — | 1.0 | 3.0 | — | A | 43 | 60 | 98 | 0.92 |
| 40 | C-4 | — | 3.0 | 5.0 | — | B | 41 | 60 | 104 | 1.05 |
| 41 | C-6 | — | 3.0 | 12.0 | — | A | 45 | 70 | 110 | 0.93 |
| 42 | C-8 | — | 3.0 | 3.0 | — | A | 40 | 66 | 156 | 1.76 |
| 43 | C-7 | — | 3.0 | 3.0 | — | A | 56 | 102 | 148 | 0.90 |
| 44 | C-3 | LX-1 | 3.0 | 3.0 | 2.0 | A | 18 | 48 | 97 | 1.65 |
| 45 | C-3 | LX-2 | 3.0 | 3.0 | 2.0 | A | 40 | 63 | 100 | 0.95 |
| 46 | C-3 | LX-2 | 3.0 | 3.0 | 5.0 | A | 41 | 65 | 98 | 0.88 |
| 47 | C-3 | LX-3 | 3.0 | 3.0 | 2.0 | A | 45 | 82 | 145 | 1.22 |
| 48 | C-7 | LX-2 | 3.0 | 3.0 | 2.0 | A | 35 | 75 | 143 | 1.44 |

### <<Evaluation of Cyan Ink>>

Cyan Inks 1-48, prepared as above, were evaluated on each of the evaluations below. Table 2 shows the results.

(Evaluation of Dispersion Stability of Liquid Cyan Ink Composition)

After placing each cyan ink prepared as above in a vessel, the vessel was sealed and stored at 60° C. for 7 days. Subsequently, the average diameter of pigment particles or minute colored particles was determined and the resulting liquid ink composition was visually observed. The storage stability of each of the inks was evaluated based on the criteria below.

A: the variation ratio of the average particle diameter was less than 5 percent and no coagulated precipitates were noticed

B: the variation ratio of the average particle diameter was 5-10 percent and coagulation precipitates were barely noticed

C: the variation ratio of the average particle diameter was 10-15 percent and slight coagulation precipitates were noticed

D: the variation ratio of the average particle diameter was 15-20 percent and no coagulated precipitates were clearly noticed

E: the variation ratio of the average particle diameter was at least 20 percent and a fairly large amount of particles was coagulate-precipitated

Ranks A, B, and C were judged to result in no problems for the practical use.

(Evaluation of Ejection Stability)

Each of the inks, prepared as above, was placed in a printer constituted in such a manner as: a diameter of the nozzle opening of 20 μm, a driving frequency of 30 kHz, ink droplets of 3.8 pl, 128 nozzles per color, a nozzle density of 180 dpi (dpi refers to the number of dots per inch or 2.54 cm), and a maximum recording density of 720×720 dpi. Under an ambience of 23° C. and 20 percent relative humidity), an image comprised of ten 1 cm×10 cm wedge charts arranged on an A4 size sheet to leave non-image area at an equal distance was continuously printed on 9 sheets. Thereafter, printing was suspended for 5 minutes and then the 10th sheet was printed. The ejection state of the nozzles during printing of the 10th sheet as well as the output image was visually observed, whereby the ejection stability was evaluated based on the criteria below.

A: no difference in the ejection state was noticed along with all nozzles

B: oblique ejection was noticed for one or two percent by number of the nozzles but no ink ejection was noticed

C: no ink ejection occurred for 3-9 percent by number of the nozzles

D: no ink ejection occurred for 10 or more percent of the nozzles.

Ranks A, B, and C, were judged to result in no problems for the practical use.

### <<Evaluation of Cyan Images>>

Images were formed employing each of the cyan inks prepared as above, and the resulting images were evaluated on the items described below. Table 2 shows the results.

(Determination of L*a*b*)

After loading each of the cyan inks prepared as above in an ink-jet cartridge, a solid cyan image was printed on Konica Photo Jet Paper Photolike QP Glossy Paper (being a porous ink-jet recording medium, manufactured by Konica Corp.) without any post-treatment, employing colored ink-jet printer PM-800 (manufactured by Epson Corp.).

L*a*b* of the resulting solid cyan image was determined under conditions of C light source: 2 degrees, range: 3, incident angle: −45 degrees, and detection angle: 45 degrees, employing GL2000, manufactured by Nippon Denshoku Industries Co., Ltd.

(Evaluation of Feeling of Gloss (Bronzing))

The solid cyan image prepared as above was visually observed regarding the feeling of gloss and the degree of bronzing. The feeling of gloss was evaluated based on the criteria below.

A: the image exhibited a marked feeling of gloss, and no bronzing was noticed

B: the image exhibited a definite feeling of gloss, and bronzing was barely noticed

C: the image exhibited a slightly reduced feeling of gloss, and slight bronzing was clearly noticed

D: the image exhibited no feeling of gloss, and marked bronzing was noticed

TABLE 2

| | Ink | | Characteristics of | | | | |
|---|---|---|---|---|---|---|---|
| | Characteristics | | Solid Cyan Image | | | | |
| Cyan | Dispersion | Ejection | | | | Feeling | |
| Ink No. | Stability | Stability | L* | a* | b* | of Gloss | Remarks |
| 1 | B | B | 73.2 | 38.5 | −10.5 | D | Comp. |
| 2 | B | B | 67.9 | 27.6 | −5.3 | D | Comp. |
| 3 | C | C | 64.4 | 16.4 | −5.2 | C | Inv. |
| 4 | B | B | 71.8 | 6.1 | −9.6 | B | Inv. |
| 5 | B | B | 69.3 | 6.4 | −7.8 | B | Inv. |
| 6 | B | B | 69.3 | 7.2 | −3.4 | B | Inv. |
| 7 | B | B | 73.2 | 7.2 | −7.8 | B | Inv. |
| 8 | B | B | 69.6 | 5.4 | −2.3 | B | Inv. |
| 9 | C | C | 74.3 | 16.7 | −3.8 | B | Inv. |
| 10 | E | D | 71.8 | 20.4 | −3.2 | D | Comp. |
| 11 | B | B | 69.8 | 9.2 | −0.7 | B | Inv. |
| 12 | B | B | 72.3 | 24.3 | −6.4 | D | Comp. |
| 13 | B | B | 67.4 | 15.2 | −5.2 | C | Inv. |
| 14 | B | B | 70.8 | 8.6 | −3.8 | B | Inv. |
| 15 | B | B | 72.8 | 7.6 | −5.6 | B | Inv. |
| 16 | B | B | 69.5 | 6.5 | −2.3 | B | Inv. |
| 17 | B | B | 73.2 | 7.7 | −4.6 | B | Inv. |
| 18 | B | B | 69.6 | 9.8 | −7.3 | B | Inv. |
| 19 | C | C | 72.3 | 14.3 | −3.8 | C | Inv. |
| 20 | C | C | 68.4 | 20.5 | −7.3 | C | Inv. |
| 21 | E | D | 70.2 | 23.2 | −4.5 | D | Comp. |
| 22 | A | A | 64.5 | 21.4 | −2.1 | D | Comp. |
| 23 | A | A | 69.5 | 7.2 | −6.4 | A | Inv. |
| 24 | A | A | 72.5 | 5.3 | −7.3 | A | Inv. |
| 25 | A | A | 68.3 | 6.9 | −2.3 | A | Inv. |
| 26 | A | A | 72.8 | 7.4 | −5.8 | A | Inv. |
| 27 | A | A | 69.6 | 4.8 | −2.3 | A | Inv. |
| 28 | C | C | 74.3 | 15.8 | −4.6 | B | Inv. |
| 29 | A | A | 68.6 | 14.7 | −5.8 | B | Inv. |
| 30 | A | A | 71.2 | 5.6 | −1.2 | A | Inv. |
| 31 | A | A | 69.3 | 6.4 | −4.6 | A | Inv. |
| 32 | A | B | 68.3 | 5.5 | −3.6 | A | Inv. |
| 33 | C | C | 70.5 | 13.9 | −5.7 | B | Inv. |
| 34 | C | C | 71.3 | 10.3 | −4.3 | B | Inv. |
| 35 | A | A | 73.2 | 7.8 | −3.6 | A | Inv. |
| 36 | A | A | 68.3 | 20.3 | −5.6 | D | Comp. |
| 37 | A | A | 68.3 | 7.2 | −3.2 | A | Inv. |
| 38 | A | A | 71.2 | 6.1 | −2.8 | A | Inv. |
| 39 | A | A | 69.3 | 5.6 | −0.6 | A | Inv. |
| 40 | A | A | 72.5 | 6.6 | −3.5 | A | Inv. |
| 41 | A | B | 67.5 | 4.5 | −2.3 | A | Inv. |
| 42 | C | C | 69.3 | 12.2 | −3.5 | B | Inv. |
| 43 | B | B | 70.3 | 11.8 | −4.6 | B | Inv. |
| 44 | A | A | 72.6 | 6.6 | −1.2 | A | Inv. |
| 45 | A | A | 69.5 | 5.8 | −3.3 | A | Inv. |
| 46 | A | A | 70.3 | 6.7 | −2.4 | A | Inv. |
| 47 | C | C | 68.8 | 10.8 | −3.4 | B | Inv. |
| 48 | C | C | 70.7 | 10.4 | −0.5 | B | Inv. |

Comp.; Comparative Example
Inv.; Present Invention

As can clearly be seen from Table 2, the cyan inks of the present invention, which comprised either pigment particles or water-insoluble colored particles and formed such images that their values on the chromaticity diagram were within the range of −20<a*<20, and −20<b*<−20, when 65<L*<75 is specified, exhibited desired dispersion stability and ejection stability, as well as excellent feeling of gloss, compared to comparative examples.

### Example 2

### <<Preparation of Each Colored Ink>>

(Preparation of Dye Ink)

(Preparation of Yellow Dye Ink)

The components described below were mixed and well stirred. Subsequently, the resulting mixture was filtered employing a membrane filter at a pore diameter of 0.45 μm, whereby Dye Ink Y was prepared.

| | |
|---|---|
| C.I. Direct Yellow 132 | 2.5 weight % |
| Tripropylene glycol | 5.0 weight % |
| Propylene glycol | 10.0 weight % |
| 2-Propanol | 2.0 weight % |

Olfin E1010 (manufactured by Nissin

| | |
|---|---|
| Olfin E1010 (manufactured by Nissin | 1.0 weight % |
| Chemical Co., Ltd.) | |
| Ion-exchange water | 79.5 weight % |

(Preparation of Magenta Dye Ink)

Dye Ink M was prepared in the same manner as aforesaid Dye Ink Y, except that C.I. Direct Yellow 132 was replaced with a mixture of Compound M-1 and Compound M-2 in an equal amount.

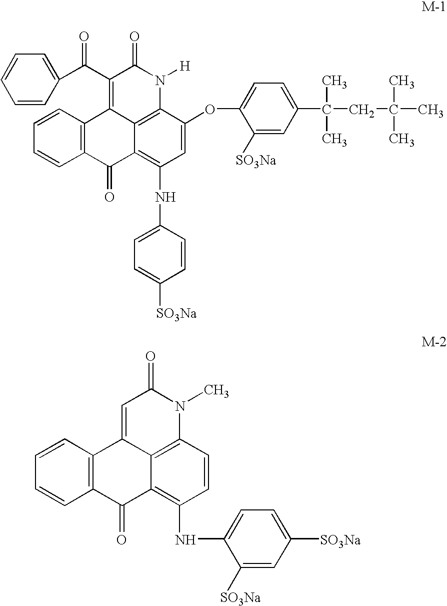

(Preparation of Cyan Dye Ink)

Dye Ink C was prepared in the same manner as aforesaid Dye Ink Y, except that water-soluble C.I. Direct Yellow 132 was replaced with water-soluble C. I. Direct Blue 199.

(Preparation of Black Ink)

Dye Ink K was prepared in the same manner as aforesaid Dye Ink Y, except that water-soluble C.I. Direct Yellow 132 was replaced with water-soluble C. I. Food Black 2.

(Preparation of Pigment Inks)

(Preparation of Yellow Pigment Inks)

Yellow Inks Y-1-Y-4 were prepared in the same manner as Cyan Inks 4, 14, 24, and 38 described in Example 1, except that regarding pigments, C.I. Pigment Blue 15: 3 was replaced with C.I. Pigment Yellow 180.

(Preparation of Magenta Pigment Inks)

Magenta Inks M-1-M-4 were prepared in the same manner as Cyan Inks 4, 14, 24, and 38 described in Example 1, except that regarding pigments, C.I. Pigment Blue 15: 3 was replaced with C.I. Pigment Red 122.

(Preparation of Black Pigment Inks)

Black Inks K-1-K-4 were prepared in the same manner as Cyan Inks 4, 14, 24, and 38 described in Example 1, except that regarding pigments, C.I. Pigment Blue 15: 3 was replaced with carbon black.

Table 3 shows measurement values of the colorant concentration, the total polymer component amount, and the size distribution of each of the colored inks prepared as above.

TABLE 3

| | | | Total | | | | |
|---|---|---|---|---|---|---|---|
| | | | Polymer | | | | |
| | | | Com- | | | | |
| | | Colorant | ponent | Size Distribution Value | | | |
| Ink | Ink | Concentration | Amount | D₁₀ | D₅₀ | D₉₀ | Polydispersity |
| Type | No. | weight % | weight % | (nm) | (nm) | (nm) | Index |
| Yellow | Y-1 | 3.0 | 7 | 56 | 82 | 120 | 0.78 |
| Ink | Y-2 | 3.0 | 9 | 53 | 80 | 123 | 0.88 |
| | Y-3 | 3.0 | 5 | 25 | 48 | 72 | 0.98 |
| | Y-4 | 3.0 | 5 | 43 | 75 | 102 | 0.79 |
| Magenta | M-1 | 3.0 | 7 | 45 | 75 | 115 | 0.93 |
| Ink | M-2 | 3.0 | 9 | 47 | 77 | 110 | 0.82 |
| | M-3 | 3.0 | 5 | 23 | 45 | 89 | 1.47 |
| | M-4 | 3.0 | 5 | 48 | 72 | 103 | 0.76 |
| Black | K-1 | 3.0 | 7 | 56 | 90 | 134 | 0.87 |
| Ink | K-2 | 3.0 | 9 | 53 | 85 | 134 | 0.95 |
| | K-3 | 3.0 | 5 | 25 | 50 | 80 | 1.10 |
| | K-4 | 3.0 | 5 | 57 | 86 | 125 | 0.79 |

### <<Evaluation of Each Ink Set>>

Each of the colored inks, prepared as above, was combined as described in Table 4, whereby Ink Sets 1-13 were prepared. Subsequently, ejection stability and the feeling of gloss were evaluated based on the methods described in Example 1, while lightfastness was evaluated based on the method described below.

(Evaluation of Lightfastness)

Based on the method described in Example 1, images were printed by overlapping each of the colored inks. The resulting sample images were subjected to irradiation for 48 hours employing an Xe fade meter (at 70,000 lux). Subsequently, the visual density of non-irradiated and irradiated samples was measured employing an X-rite 938 spectrodensitometer (measurement condition C light source), and lightfastness was evaluated based on the criteria below.

Residual ratio (percent)=(reflection density of irradiated sample)/(reflection density of non-irradiated sample)

A: the residual ratio was at 95 percent

B: the residual ratio was 90-95 percent

C: the residual ratio was 80-90 percent

D: the residual ratio was less than 80 percent

TABLE 4

| | | | | | Individual Evaluation | | | |
|---|---|---|---|---|---|---|---|---|
| | | | | | Result | | | |
| Ink | | | | | Feeling | | | |
| Set | Ink Constitution | | | | of | Ejection | Light- | |
| No. | Yellow | Magenta | Cyan | Black | Gloss | Stability | fastness | Remarks |
| 1 | Dye Ink Y | Dye Ink M | Dye Ink C | Dye Ink K | A | A | D | Comp. |
| 2 | Dye Ink Y | Dye Ink M | 4 | Dye Ink K | A | A | C | Inv. |
| 3 | Y-1 | M-1 | 4 | K-1 | A | A | C | Inv. |
| 4 | Y-1 | M-1 | 2 | K-1 | D | D | C | Comp. |
| 5 | Dye Ink Y | Dye Ink M | 14 | Dye Ink K | A | A | C | Inv. |
| 6 | Y-2 | M-2 | 14 | K-2 | A | A | A | Inv. |
| 7 | Y-2 | M-2 | 12 | K-2 | D | D | A | Comp. |
| 8 | Dye Ink Y | Dye Ink M | 24 | Dye Ink K | A | A | C | Inv. |
| 9 | Y-3 | M-3 | 24 | K-3 | A | A | A | Inv. |
| 10 | Y-3 | M-3 | 22 | K-3 | D | D | A | Comp. |
| 11 | Dye Ink Y | Dye Ink M | 38 | Dye Ink K | A | A | C | Inv. |
| 12 | Y-4 | M-4 | 38 | K-4 | A | A | A | Inv. |
| 13 | Y-4 | M-4 | 36 | K-4 | D | D | A | Comp. |

Comp.; Comparative Example
Inv.; Present Invention

As can clearly be seen from Table 4, Ink Sets comprising the cyan ink of the present invention exhibited excellent ink ejection stability, and resulted in excellent feeling of gloss and lightfastness, compared to comparative examples.

Based on the present invention, it is possible to provide a water-based cyan ink-jet ink which exhibits improved dispersion stability and ejection stability of ink and also results in an excellent feeling of gloss (bronzing resistance), excellent lightfastness of the formed images, as well as an ink-jet color ink set and an image forming method using the same.

What is claimed is:

1. A water-based cyan ink for ink-jet printing, comprising pigment particles or water insoluble colored polymer particles,
wherein an ink-jet image is formed by jetting the water-based cyan ink on a porous ink-jet recording sheet with an ink-jet printer without being subjected to an post-treatment, and the ink-jet image has the following set of color coordinate values in a L*a*b* color space when L* is in a range of 65<L*<75:
(i) −20<a*<20; and
(ii) −20<b*<20.

2. The water-based cyan ink of claim 1, wherein the pigment particles or the water insoluble colored polymer particles has a volume average particle diameter of 10 to 200 nm.

3. The water-based cyan ink of claim 1 further comprises a water-soluble polymer and secondary particles of the pigment particles or the water insoluble colored polymer particles satisfy Formula (1):
10X^{-0.7}<Y<40X^{-0.7} Formula (1)
wherein X is a volume average particle diameter; and
Y is a polydispersity index which is defined by the following formula:
Y=(D₉₀-D₁₀)/D₅₀,
wherein D₉₀, D₅₀, and D₁₀ are respectively particle diameters at which an integral of a distribution function dG (dG=F(D)×dD) is equal to 90 volume %, 50 volume % and 10 volume % of the total volume of the secondary particles or the water insoluble colored polymer particles, wherein G is a volume of the particle, D is a diameter of the secondary particle and F(D) is a volume frequency function.

4. The water-based cyan ink of claim 1 further comprises a water-soluble polymer in an amount of not less than 2 times of weight of the pigment particles or the water insoluble colored polymer particles.

5. The water-based cyan ink of claim 1, wherein the water insoluble colored polymer particles are covered with a pigment or a dye on a surface of the particles.

6. The water-based cyan ink of claim 5, wherein a weight ratio of the polymer to the pigment is 0.6:1 to 10:1.

7. The water-based cyan ink of claim 5, wherein a weight ratio of the polymer to the dye is 0.4:1 to 10:1.

8. An ink set for ink-jet printing containing a water-based cyan ink which comprises pigment particles or water insoluble colored polymer particles,
wherein an ink-jet image is formed by jetting the ink set on a porous ink-jet recording sheet with an ink-jet printer without being subjected to an post-treatment, and the ink-jet image has the following set of color coordinate values in a L*a*b* color space when L* is in a range of 50<L*<90:
(i) −20<a*<20; and
(ii) −20<b*<20.

9. An ink set for ink-jet printing containing the water-based cyan ink of claim 3.

10. A method for producing an ink-jet image using the water-based cyan ink of claim 3.

11. A method for producing an ink-jet image using the ink set of claim 8.
